(19) United States
(12) Patent Application Publication
(10) Pub. No.: US 2022/0177154 A1
(43) Pub. Date: Jun. 9, 2022

(54) TESTING SYSTEM AND METHOD FOR DETECTING ANOMALOUS EVENTS IN COMPLEX ELECTRO-MECHANICAL TEST SUBJECTS

(71) Applicant: The Boeing Company, Chicago, IL (US)

(72) Inventors: Nigel Stepp, Santa Monica, CA (US); Aruna Jammalamadaka, Agoura Hills, CA (US); Tsai-Ching Lu, Thousand Oaks, CA (US); Greg Blaire, Scottsdale, AZ (US); Joseph Wilson, Lynnwood, WA (US); Heath W. Haga, Mount Pleasant, SC (US); Mark Daniel McCleary, Seattle, WA (US); Brandon M. Courter, Mount Pleasant, SC (US); Kangyu Ni, Calabasas, CA (US)

(21) Appl. No.: 17/453,304

(22) Filed: Nov. 2, 2021

Related U.S. Application Data
(60) Provisional application No. 63/121,706, filed on Dec. 4, 2020.

(51) Int. Cl. B64D 45/00; B64D 43/00; G06N 20/00; G06K 9/62

(52) U.S. Cl. CPC B64D 45/00; B64D 43/00; B64D 2045/0085; G06K 9/6259; G06N 20/00

(57) ABSTRACT

A testing system, a testing method, and a training method for the testing system are disclosed. According to an example, a computing system of the testing system processes a set of data streams of test data for a test subject in combination with a previously trained nominal model by, for each parameter of the test subject: selecting a parameter-specific control band defined by the nominal model for the parameter; comparing a time-based series of measurements of the test data for the parameter to the parameter-specific control band for the parameter, and selectively generating a test result for the parameter responsive to whether a condition is satisfied with respect to any of the time-based series of measurements exceeding the parameter-specific control band for the parameter.

### CROSS REFERENCE TO RELATED APPLICATIONS

This application claims priority to U.S. Provisional Patent Application Ser. No. 63/121,706, filed Dec. 4, 2020, the entirety of which is hereby incorporated herein by reference for all purposes.

### FIELD

The subject disclosure relates generally to testing electro-mechanical systems, such as aircraft.

### BACKGROUND

Complex electro-mechanical systems, such as commercial aircraft can undergo testing of electrical and mechanical subsystems during production, maintenance, or operations. Detecting anomalous events with respect to these complex systems can be time consuming and require significant human resources due, at least in part, to the vast number of parameters that can be measured with respect to the system and the dynamic nature of these events.

### SUMMARY

According to an example of the subject disclosure, a testing system, a testing method, and a method of training the testing system are disclosed. The testing system includes a computing system programmed with instructions executable by the computing system to perform a training phase with respect to electro-mechanical training subjects, and to perform a testing phase with respect to electro-mechanical test subjects using a nominal model developed as part of the training phase.

During the training phase, for each of a plurality of electro-mechanical training subjects, the computing system receives a set of training data for the training subject that comprises a time-based series of measurements for each of a plurality of parameters measured by a set of sensors associated with the training subject. For each parameter of the plurality of parameters, the computing system computes one or more parameter statistic values representing a filtered combination of the time-based series of measurements of the parameter across the plurality of training subjects, and identifies one or more control limits defining a parameter-specific control band for the parameter based on the one or more parameter statistic values computed for the parameter. The computing system generates a nominal model that includes, for each of the plurality of parameters, the one or more parameter-specific control limits defining the parameter-specific control band for the parameter.

During a testing phase, the computing system receives test data for an electro-mechanical test subject that comprises a time-based series of measurements for each of the plurality of parameters measured by a set of sensors associated with the test subject. The computing system processes the test data for the test subject in combination with the nominal model by, for each parameter of the plurality of parameters: comparing the time-based series of measurements of the parameter of the test data to the parameter-specific control band for the parameter, and selectively generating a test result for the parameter responsive to whether a condition is satisfied with respect to any of the time-based series of measurements of the test data exceeding the parameter-specific control band for the parameter.

### BRIEF DESCRIPTION OF THE DRAWINGS

FIG. 1 is a schematic diagram depicting features of an example testing system and test subject.

FIGS. 2A and 2B are flow diagrams depicting features of example workflows that can be performed using the testing system of FIG. 1.

FIG. 3 is a schematic diagram depicting features of the testing computing system of FIG. 1.

FIGS. 4A and 4B are flow diagrams depicting features of an example testing method.

FIG. 5 is a flow diagram depicting features of an example workflow with respect to the testing phase of FIG. 2A.

FIG. 6 is a schematic diagram depicting features of an example nominal model.

FIGS. 7A and 7B show example graphical representations of test data.

FIGS. 8A-8F show example graphical representations of test data.

FIG. 9 shows example test results for ordinal parameters.

FIG. 10A shows example test results for categorical parameters.

FIG. 10B shows an example graphical representation of test data.

FIG. 11 shows additional example test results for categorical parameters.

FIGS. 12A, 12B, and 12C are flow diagrams depicting features of an example training method.

FIG. 13 depicts an example parameter symbol map.

FIGS. 14A-14B shows an example rule set that includes sequential rules definitions.

FIG. 15 is a flow diagram depicting features of an example workflow with respect to the training phase of FIG. 2A.

### DETAILED DESCRIPTION

A testing system, a method for testing an electro-mechanical test subject, and a method of training the testing system are disclosed. The electro-mechanical test subject can include a vehicle (e.g., an aircraft), as an example, having a complex set of electro-mechanical subsystems. The testing system and testing method can utilize a previously trained nominal model during a testing phase with respect to the test subject to identify and distinguish nominal events from off-nominal events as part of production, maintenance, or general operation of the test subject.

Nominal events detected by the testing system and testing method can refer to events that are intended or anticipated as part of the design of the test subject, while off-nominal events can refer to events that are anomalous or not intended as part of the design of the test subject. These nominal and off-nominal events can be detected in real-time or near-real-time during the testing phase, thereby potentially reducing the time and resources associated with conducting testing, increasing efficiency of testing, and reducing manual labor costs. Alerts, for example, can be generated in real-time or near-real-time responsive to detecting off-nominal events while test data is currently being received from the test subject. Such alerts can take a variety of different forms depending on parameter type, including control chart alerts, phase space control chart alerts, counts control chart (C-chart) alerts, and sequential rule alerts, as will be described in further detail herein.

During a training phase, the nominal model can be trained by mining training data received from a set of training subjects to construct an ensemble of model components that collectively define the nominal model. These model components can be used during the testing phase to detect multiple distinct types of events as being nominal or off-nominal. As an example, the model components can detect nominal and off-nominal events with respect to a variety of different types of parameters of the test subject, including a variety of ordinal parameters and categorical parameters, thereby providing technicians and operators with a highly adaptable testing platform.

Computer-implemented programmatic discovery techniques and machine learning can be applied to training data captured from training subjects to identify highly complex, multi-parameter combinations for inclusion in the nominal model. Highly compressed parameter statistics and state-change sequences can be captured over a large set of parameters, which can be fed into analytics and machine-learning models as part of development of sequential rules within the nominal model.

The training subjects from which the training data is received can be members of a class of which the test subject is also a member. The test subjects and the training subjects, for example, can be the same model or functionally related models of commercial airliner. In at least some examples, the training and test data can be received as data packets via networks integrated with the test and training subjects that can be processed by the testing system, and the training and testing methods. Within the context of commercial airliners, for example, the Common Data Network (CDN) integrated with the aircraft can provide test and training data to a computing system that forms part of the testing system and implements the disclosed testing and training methods disclosed herein.

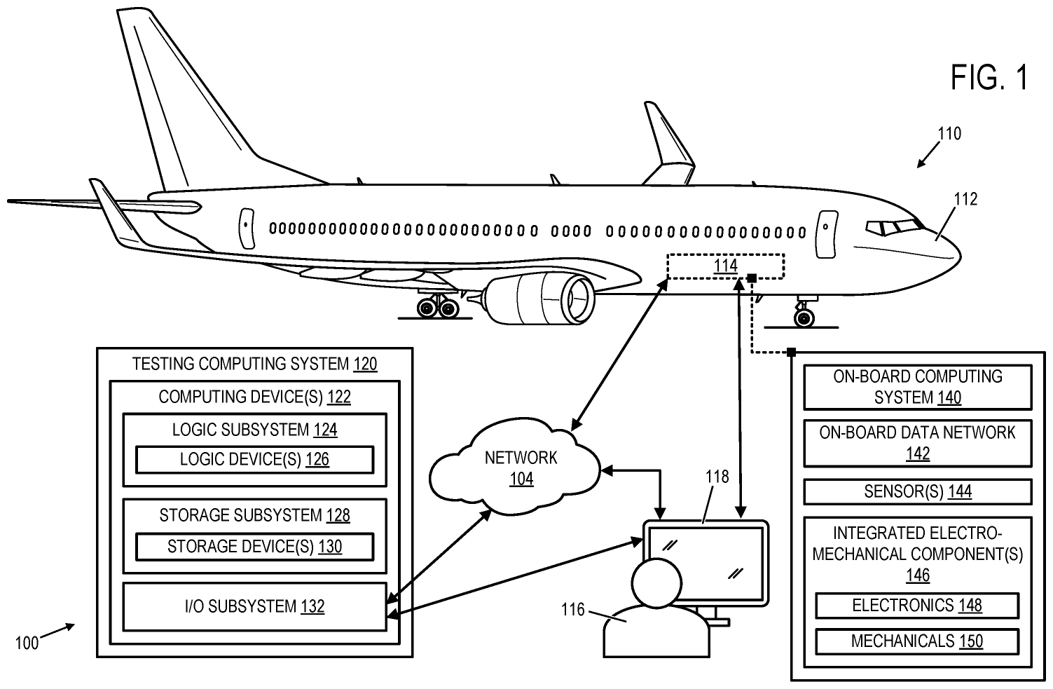

FIG. 1 is a schematic diagram depicting features of an example testing system 100 that can implement the testing and training methods disclosed herein. Testing system 100 can be applied to an electro-mechanical test subject 110, which in the example of FIG. 1 takes the form of an aircraft 112. However, an electro-mechanical test subject can take other forms, including other types of aeronautical vehicles, satellites, land vehicles, watercraft, or other types of electro-mechanical systems, including stationary systems that incorporate electronically controlled mechanical components.

Testing system 100 includes a testing computing system 120 of one or more computing devices 122. The one or more computing devices 122 collectively include a logic subsystem 124 of one or more logic devices 126 (e.g., processors), a storage subsystem 128 of one or more data storage devices 130, and an input/output subsystem 132 by which testing computing system 120 can communicate with other devices. For example, testing computing system 120 can communicate with electro-mechanical components 114 integrated with or otherwise interfacing with electro-mechanical test subject 110. As an example, aircraft 112 of FIG. 1 takes the form of a multi-passenger, commercial airliner and/or a freight aircraft having on-board electro-mechanical components that are integrated with the aircraft. In at least some examples, communications between electro-mechanical components 114 and testing computing system 120 can be over one or more intermediate communications networks 104, which provide one or more wired communications links and/or one or more wireless communications links that utilize wired and/or wireless communications protocols.

Human users represented schematically at 116 can interact with testing computing system 120 and/or electro-mechanical components 114 associated with test subject 110 via one or more computer terminals 118, represented schematically in FIG. 1. Communications between or among terminals 118, testing computing system 120, and electro-mechanical components 114 can traverse network 104. In at least some examples, one or more of terminals 118 can be integrated with testing computing system 120 and/or one or more of terminals 118 can be integrated with electro-mechanical components 114 of the test subject.

Electro-mechanical components 114 are depicted schematically in further detail in FIG. 1 as including an on-board computing system 140, an on-board data network 142, a set of one or more sensors 144 associated with test subject 110, and one or more integrated electro-mechanical components 146 of the test subject, including electronic components 148 and mechanical components 150.

On-board computing system 140 can similarly include one or more of the components previously described with reference to testing computing system 120. In an example, on-board computing system 140 can be integrated with test subject 110, and can be used to control operation of the test subject. Within the context of example aircraft 112, on-board data network 142 can be used to manage the flow of data between or among the various systems and subsystems of the aircraft, including on-board computing system 140, as well as power subsystems, electro-mechanical subsystems, flight deck subsystems, service personnel subsystems, entertainment subsystems, etc., of integrated electro-mechanical components 146, and sensor subsystems including sensors 144. As an example, on-board data network 142 can include an integrated aircraft data network, such as a CDN. On-board data network 142 can include bi-directional fiber optic and/or copper network pathway components, bridges, switches, routers, hubs, etc. over which communications and/or electrical power are communicated utilizing a set of communications protocols and standards. As an example, the Aeronautical Radio, Incorporated (ARINC) 664 standard can be used within the context of an aircraft.

Sensors 144 can be integrated with the various integrated electro-mechanical components 146 of electro-mechanical test subject 110 and/or physically interfaced with the test subject by technicians during production or maintenance. Sensors 144 can be used to measure operation and performance of integrated electro-mechanical components 146 during testing, maintenance, and/or operation of test subject 110. Sensors 134 can include a variety of sensor types that measure electrical properties of electronic components 148, such as a voltage, resistance, current, impedance, capacitance, power, etc. As an example, sensors 144 can include a battery voltage sensor that measures a voltage of a battery located on-board the test subject. Sensors 144 can include a variety of sensor types that measure physical, non-electrical properties of mechanical components 150 or other physical features of the test subject, such as a position, velocity, acceleration, force, work, impulse, pressure, temperature, quantity, presence, etc. As an example, sensors 144 can include a hydraulic pressure sensor that measures hydraulic pressure in a hydraulic actuator responsible for positioning a flight control surface, and a position sensor that measures the positioning of the flight control surface.

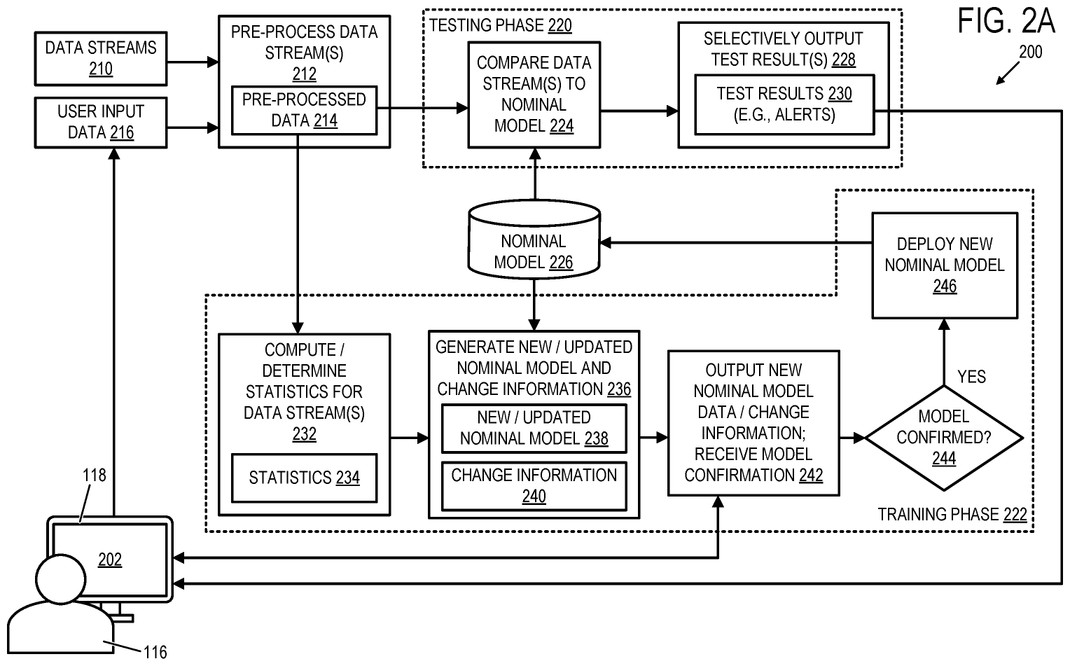

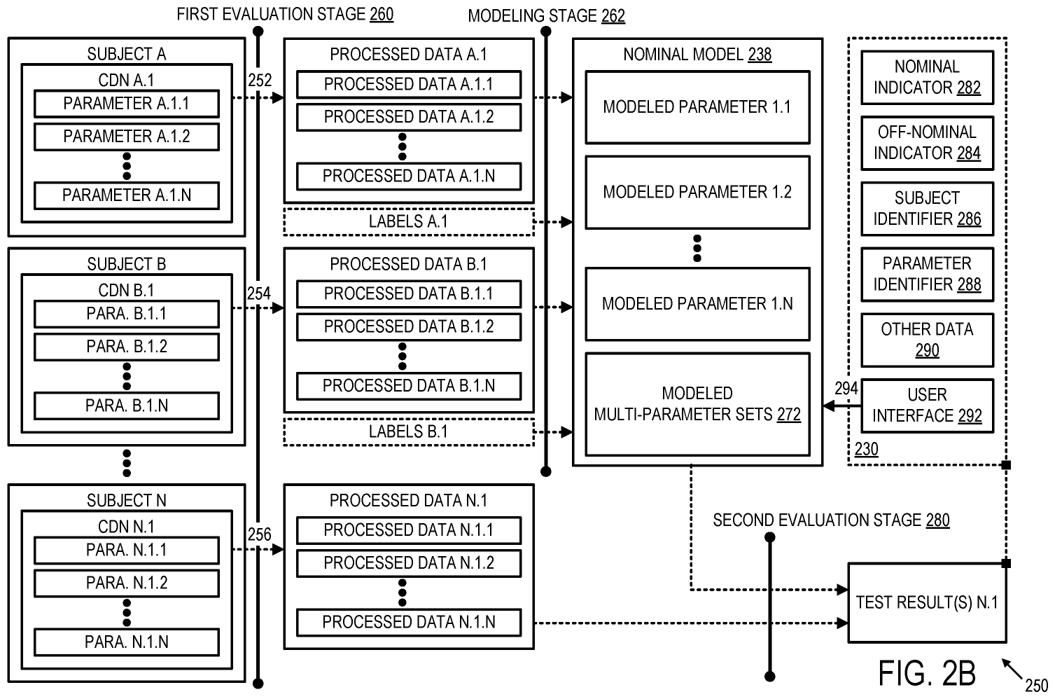

FIG. 2A is a flow diagram depicting features of an example workflow 200 that can be performed using testing system 100 of FIG. 1. As an example, workflow 200 can be performed, at least in part, by testing computing system 120 of FIG. 1.

Beginning on the left-hand side of FIG. 2A, test data and/or training data comprising a set of data streams 210 from a set of sensors associated with a test subject are received. For example, the one or more data streams 210 can represent measurements received from sensors 144 and/or reported via on-board computing system 140 of FIG. 1. Data streams 210 can be pre-processed by testing computing system 120 at 212 to obtain pre-processed data 214. This pre-processed data 214 can be subsequently used in a testing phase 220 (as test data) and in a training phase 222 (as training data).

The one or more data streams 210 can be received as an output from sensors 144 and/or on-board computing system 140 via on-board data network 142 and/or via intermediate network 104 of FIG. 1. Data streams 210 can be received by testing computing system 120 as digital, packetized, encoded data, for example. Data streams 210 can be formatted according to one or more communications protocols and standards, such as ARINC 664, within the context of the test or training subjects being aircraft.

Data streams 210 can be decoded and filtered by testing computing system 120 into a plurality of data streams corresponding to a plurality of parameters as part of pre-processing at 212. As an example, within the context of CDN data formatted according to ARINC 664, normalized throughput/area (NTAR) decoding and ATA-24 parameter filtering can be performed as part of pre-processing at 212. However, it will be understood that parameter filtering for other ATA chapters can be supported by the testing system disclosed herein with respect to aircraft.

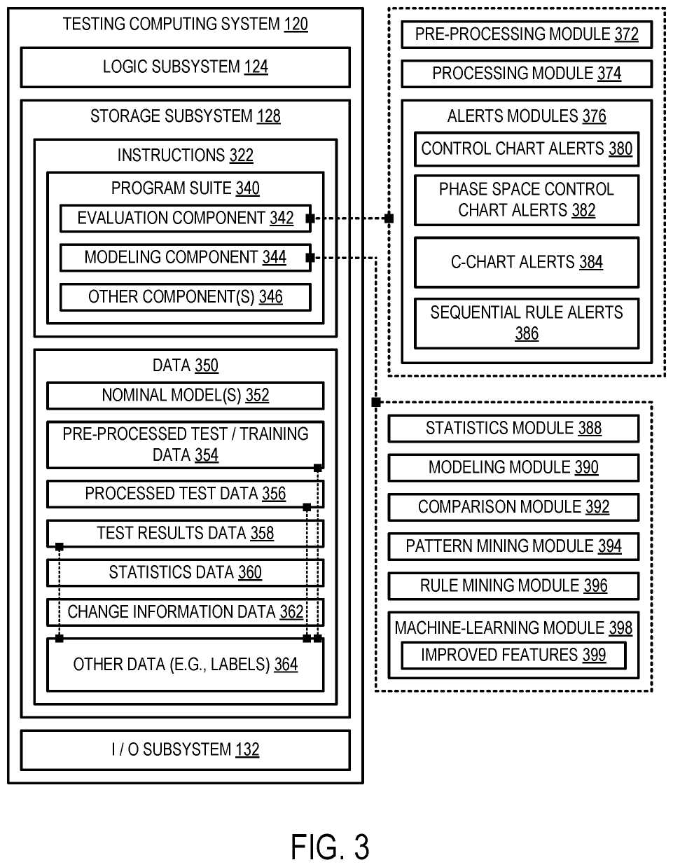

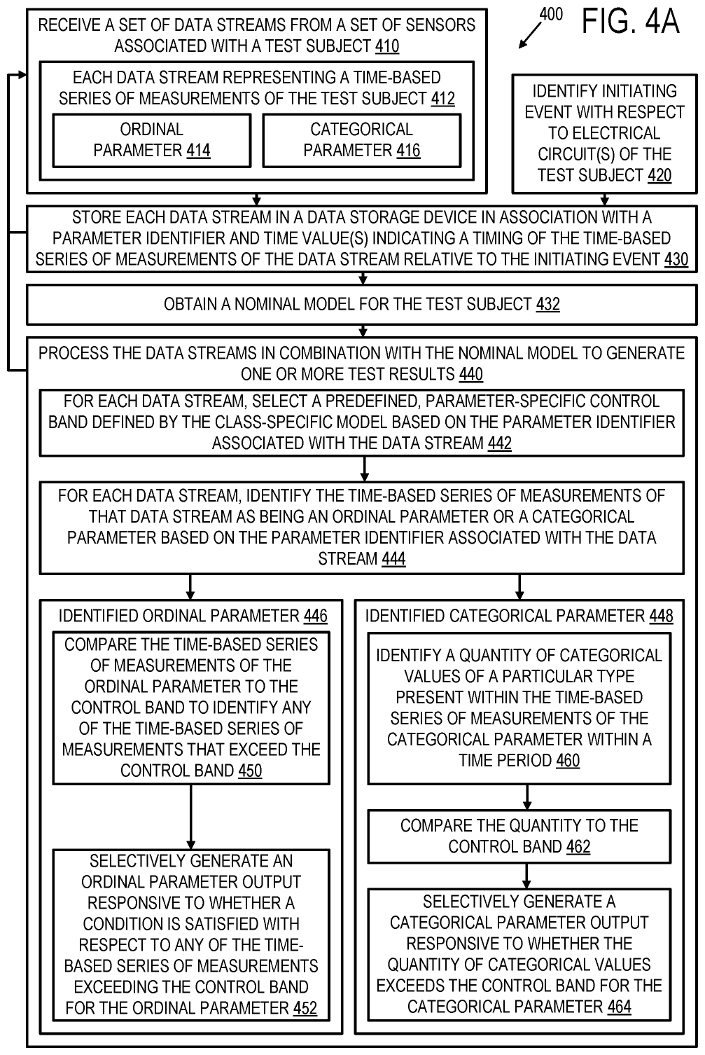

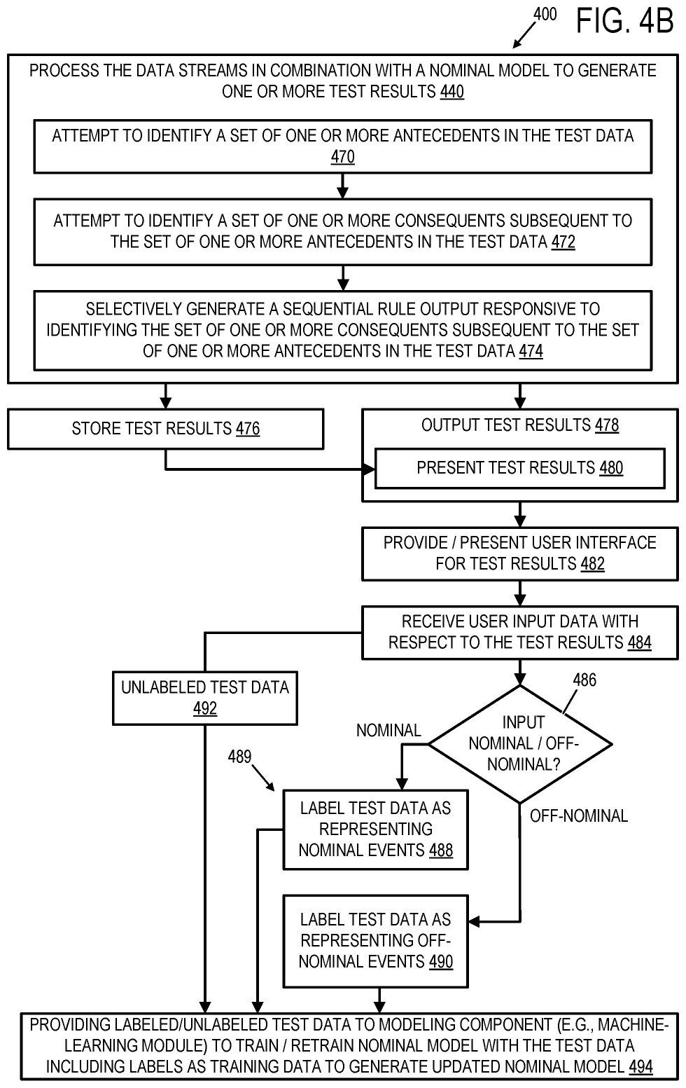

Each of the decoded and filtered data streams of pre-processed data 214 can represent a time-based series of measurements for a particular parameter of the test subject. Such data can be associated with a parameter identifier and/or timing data within pre-processed data 214 as part of the pre-processing operations performed at 212, as will be described in further detail with reference to FIGS. 3, 4A, and 4B. Parameter identifiers and/or timing information can be included within data streams 210, in at least some examples. However, in other examples, parameter identifiers and/or timing information can be associated with data streams 210 as part of the pre-processing performed at 212.

Furthermore, in at least some examples, data streams 210 can be initially formatted as a multiplex of many data streams generated by sensors 144 and/or reported via on-board computing system 140, in which case pre-processing performed at 212 can include demultiplexing the multiplexed data streams to obtain a data stream of measurements for each parameter of the test subject within pre-processed data 214. As an example, data streams 210 can include tens, hundreds, thousands or more data streams received in parallel.

Raw data streams 210 and pre-processed data 214 can be stored within data storage subsystem 128 of testing computing system 120. Within the context of real-time or near-real-time implementations, data streams 210 and/or pre-processed data 214 can be buffered within data storage subsystem 128, from which the testing computing system can retrieve, process, and store data at a rate suitable for the processing capability of the computing system.

User input data 216 representing one or more user inputs can be received by testing computing system 120 via one or more of terminals 118 operated by one or more users 116. As an example, user input data 216 can direct testing computing system 120 to implement either the testing phase 220 or the training phase 222 using pre-processed data 214. As another example, user input data 216 can be provided by a user to select a particular subset of data streams 210 and/or pre-processed data 214 for the testing phase 220 or the training phase 222. For example, pre-processed data 214 can include data streams 210 processed at 212 for two or more (e.g., tens, hundreds, thousands, etc.) test and/or training subjects. As yet another example, user input data 216 can be provided for model refinement such as to label training data or test results data as being nominal or off-nominal on a per-parameter basis. These labels can be used by the testing system during the training phase 222 to programmatically define features of the nominal model.

As part of the testing phase 220, at 224, data streams of pre-processed data 214 can be compared by testing computing system 120 to a previously trained nominal model 226, and one or more test results 230 of the comparison can be selectively output by the testing computing system at 228. As an example, test results 230 output at 228 can include alerts indicating off-nominal events (e.g., anomalies) with respect to the test subject from which data streams 210 of the test data were received. Results 230 can be output via terminals 118 for presentation to users 116, for example, via a graphical user interface (GUI) 202 presented via a graphical display of the terminals. Results 230 can include data represented in textual forms (e.g., alphanumeric text) and/or graphical forms (e.g., charts).

As part of the training phase 222, at 232, testing computing system 120 can determine or otherwise compute one or more statistics 234 for measured values within each of the data streams of pre-processed data 214. Within the context of the training phase 222, pre-processed data 214 can be referred to as training data that is used as part of training and development of nominal models.

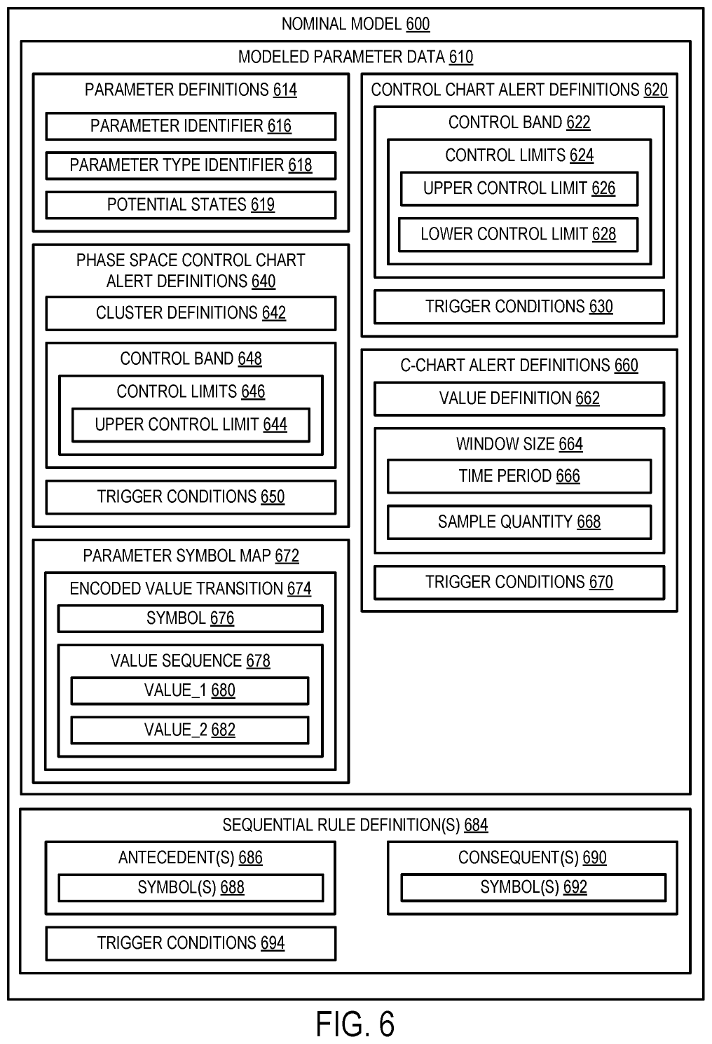

Examples of statistics 234 can include, for each parameter of a training subject, a minimum of the measured values, a maximum of the measured values, a mean or average of the measured values, a standard deviation of the measured values, a sample of the measured values, an indication of one or more types of the measured values, a count of a feature present within the measured values, a distribution of the measured values, phase space value sets computed for ordinal parameters, and symbolic coding of the measured values (e.g., encoded value transitions described with respect to FIG. 6). Statistics 234 determined at 232 can incorporate pre-processed data 214 from any suitable number of training subjects. These training subjects can refer to an instance of example test subject 110 of FIG. 1. For example, training data can be received from multiple aircraft of a class of which aircraft 112 of FIG. 1 is also a member. Statistics 234 determined at 232 can be stored within data storage subsystem 128 of testing computing system 120.

At 236, testing computing system 120 can generate a new or updated nominal model (e.g., 238) by combining the data streams of pre-processed data 214 and/or statistics 234 determined at 232 for one or more training subjects. Additionally or alternatively, if existing nominal model 226 is available to testing computing system 120, one or more data streams of pre-processed data 214 and/or statistics 234 determined at 232 for one or more training subjects can be combined with data of the existing nominal model to generate new or updated nominal model 238. Additionally, at 236, change information 240 can be generated by testing computing system 120 based on a comparison of new nominal model 238 to existing nominal model 226. Change information can take the form of textual information and/or graphical information that identifies differences between existing nominal model 226 and new nominal model 238. New nominal model 238 and change information 240 can be stored within data storage subsystem 128 of testing computing system 120.

At 242, change information 240 and/or data of new nominal model 238 can be output by testing computing system 120 via one or more of terminals 118 for presentation to one or more users 116, for example, via GUI 202. Additionally, statistics 234 and pre-processed data 214 for individual training subjects can be output by computing system 120 at terminals 118, for example, via GUI 202. Change information 240, data of new nominal model 238, statistics 234, and pre-processed data 214 can be presented in textual forms (e.g., alphanumeric text) and/or graphical forms (e.g., charts) at terminals 118.

As part of outputting the change information 240 and/or data of the new nominal model 238 at 242, testing computing system 120 can prompt users 116 via terminals 118 as to whether new nominal model 238 should be deployed to the testing phase 220 in place of existing nominal model 226. At 242, computing system 120 can receive a model confirmation to deploy the new nominal model from users 116 of terminals 118. As example, the following prompt can be presented by testing computing system 120 to users 116 via GUI 202 of terminals 118: “Please take a look at the results in compare 872. Enter ‘Y’ or ‘yes’ if you would like to update the nominal model, or enter ‘N’ or ‘no’ to exit without updating.” Responsive to entering ‘Y’ or ‘yes’ within a command line or via a graphical selector, at 244, testing computing system 120 determines that an update to the nominal model has been confirmed by a user, and outputs “Updating existing nominal model” via GUI 202 of terminals 118. Thus, at 244, if the update was confirmed by the user input data, the workflow proceeds to 246 where new nominal model 238 is deployed in place of existing nominal model 226 (if such model exists) for use in the testing phase 220. As part of user input data 216, users 116 can select one of a plurality of nominal models to use in testing phase 220, including new nominal model 238 and existing nominal model 226, as examples.

FIG. 2B is a flow diagram depicting features of an example workflow 250 that can be performed using testing system 100 of FIG. 1 with respect to a plurality of electro-mechanical test and training subjects schematically represented as subject A, subject B, subject N, etc. FIG. 2B depicts many of the same features described with reference to FIG. 2A, but with respect to multiple test and training subjects. Similar to workflow 200 of FIG. 2A, workflow 250 can be performed, at least in part, by testing computing system 120 of FIG. 1 with respect to data received from any suitable quantity of test and training subjects.

In this example, multiple sets of training data are received by testing system 100 from a plurality of electro-mechanical training subjects. For example, training data 252 is received by testing system 100 from electro-mechanical training subject A, training data 254 is received by the testing system 100 from electro-mechanical training subject B, etc. for each of the training subjects. Training data 252 and 254 can refer to respective sets of data streams 210 of FIG. 2A. Training data 252 of subject A, for example, can be received by testing system 100 via an on-board data network of subject A, which is represented schematically in FIG. 2B by CDN A.1. Parameters of subject A for which measurements are present in training data 252 are represented schematically in FIG. 2B as parameters A.1.1, A.1.2, A.1.N, etc.

Furthermore, in this example, subject B is of the same class of electro-mechanical system as subject A. For example, test subject A and test subject B can refer to the same model of aircraft. Accordingly, training data 254 can be similarly received by testing system 100 via an on-board data network of subject B, which is represented schematically in FIG. 2B by CDN B.1. Parameters of subject B for which measurements are present in training data 254 are represented schematically in FIG. 2B as parameters B.1.1, B.1.2, B.1.N, etc. Furthermore, in this example, parameter A.1.1 of subject A corresponds to parameter B.1.1 of subject B, parameter A.1.2 of subject A corresponds to parameter B.1.2 of subject, B, and parameter A.1.N of subject A corresponds to parameter B.1.N of subject B, etc.

A first evaluation stage 260 of testing system 100 represented schematically in FIG. 2B receives and processes training data received from the plurality of training subjects, including training data 252 of subject A and training data 254 of subject B to obtain processed data for the plurality of training subjects. First evaluation stage 260 of FIG. 2B can include the pre-processing operations performed at 212 and the determining of statistics performed at 232 of FIG. 2A as part of the training phase 222. The processed data that is obtained for each training subject can include processed forms of the training data for each parameter of the training subject. In this example, processed data A.1 that was obtained from training data 252 for subject A includes processed data A.1.1, A.1.2, A.1.N for parameters A.1.1, A.1.2, A.1.N, respectively. Similarly, processed data B.1 that was obtained from training data 254 for subject B includes processed data B.1.1, B.1.2, B.1.N for parameters B.1.1, B.1.2, B.1.N, respectively.

In at least some examples, processed data A.1 and B.1 can be reviewed by users 116 via terminals 118 of FIG. 2A as part of the training phase 222. Labels A.1 and B.1 can optionally be provided by users 116 as user input data 216 received via terminals 118. As an example, labels A.1 can identify whether processed data A.1 represents nominal events or off-nominal events on a per-parameter basis. Similarly, labels B.1 can identify whether processed data B.1 represents nominal events or off-nominal events on a per-parameter basis.

At a modeling stage 262, processed data and user-applied labels (A.1, B.1, etc., if any) can be used by testing system 100 to generate nominal model 238 of FIG. 2A. For example, labels A.1 and B.1 can be used to by testing system 100 to programmatically define or refine features of the nominal model. Modeling stage 262 can include the generation of a new nominal model and change information at 236 of FIG. 2A, as examples. Within FIG. 2B, nominal model 238 that is generated as part of the modeling stage 262 is shown schematically including modeled parameters 1.1, 1.2, 1.N, etc. that is based on the training data received for each parameter of the plurality of training subjects. For example, modeled parameter 1.1 can be based on processed training data A.1.1 and B.1.1 of training subjects A and B. Similarly, modeled parameter 1.2 can be based on processed training data A.1.2 and B.1.2 of training subjects A and B. Furthermore, in at least some examples, nominal model 238 can include one or more modeled multi-parameter sets 272, which can include sequential rules derived from training data of two or more different parameters of the training subjects.

Following generation of nominal model 238, test data 256 can be received by testing system 100 from a test subject N. Test data 256 can refer to another set of data streams 210 of FIG. 2A, for example. Furthermore, in this example, subject N is also of the same class of electro-mechanical system as subject A and subject B. For example, subjects A, B, and N can refer to the same model of aircraft. Accordingly, training data 256 can be similarly received by testing system 100 via an on-board data network of subject N, which is represented schematically in FIG. 2B by CDN N.1. Parameters of subject N for which measurements are present in test data 256 are represented schematically in FIG. 2B as parameters N.1.1, N.1.2, N.1.N, etc., and can correspond to the previously described parameters of subjects A and B.

Test data 256 can be similarly processed by testing system 100 via first evaluation stage 260 to obtain processed data N.1, including processed data N.1.1, N.1.2, N.1.N, etc. for parameters N.1.1, N.1.2, N.1.N, etc. As subject N is a test subject in this example, processed data N.1 can be processed by testing system 100 in combination with nominal model 238 via a second evaluation stage 280 to generate test results N.1 for subject N. Second evaluation stage 280 can include testing phase 220 of FIG. 2A, as an example.

Within FIG. 2B, test results N.1 is an example of test results 230 of FIG. 2A for a particular test subject N. As depicted schematically in FIG. 2B, test results 230 of FIG. 2A can include, for each parameter of the test subject, a nominal indicator 282 or an off-nominal indicator 284 that indicates whether the test data for that parameter represents a nominal or off-nominal event based on the comparison of the test data to the nominal model, a subject identifier 286 that identifies the test subject (e.g., subject N), a parameter identifier 288 that identifies the parameter (e.g., battery current), and other data 290, which can include a timing identifier that identifies a timing of off-nominal events within the test data, control limits of the nominal model applied to the test data for the parameter, alert type identifiers, and other suitable data as provided by the various example test results disclosed herein.

As further depicted schematically in FIG. 2B, test results 230 of FIG. 2A can include, for each parameter and/or combinations of parameters of the test subject, a user interface 292 by which users 116 can label or re-label the test data as representing a nominal or off-nominal event. User interface 292 can take the form of a command line, form field, graphical selector, etc. of a GUI, as an example. However, natural language, voice-based interfaces or other suitable user interfaces can be used.

As a first example, an initial set of test results for a test subject could indicate an off-nominal event for one or more parameters measured for the test subject. In response to the test results indicating the off-nominal event, a user can provide user input represented by user input data 294 via user interface 292 to label the off-nominal event indicated by the test results as either an off-nominal event (e.g., confirming the test results for the one or more parameters) or a nominal event (e.g., indicating that the test results for the one or more parameters were inaccurate). User input data 294 can be stored and utilized by testing system 100 to train or re-train the nominal model as part of the training phase 222.

Responsive to user input data 294 indicating that an off-nominal event within test results is instead representative of a nominal event, testing system 100 can refine features of the nominal model for the one or more parameters, including parameter-specific control bands, control limits, sampling windows, conditions, and/or rules associated with the one or more parameters.

As an example, responsive to user input data 294 indicating that an off-nominal event within test results is instead representative of a nominal event, testing system 100 can refine a parameter-specific control band associated with the one or more parameters by programmatically expanding one or more of the control limits defining the control band so that the nominal test results are within the control limits. Upon re-running the testing phase 220 for the test data following an update to the nominal model to incorporate user input data 294, the subsequent test results can instead indicate a nominal event for the one or more parameters. As another example, responsive to user input data 294 confirming that an off-nominal event indicated by the test results for one or more parameters is representative of an off-nominal event, testing system 100 can update the nominal model by running the training phase 222 to incorporate the test data as training data, thereby reinforcing the nominal model with additional examples of off-nominal events for the one or more parameters.

As yet another example, an initial set of test results could indicate a nominal event based on an initial set of control limits of the nominal model that is applied to the test data for a parameter. Users 116 can provide user input represented by user input data via user interface 292 to label that nominal event as either nominal or off-nominal. Responsive to user input data 294 indicating that the nominal event within the test results is instead representative of an off-nominal event, testing system 100 can refine the parameter-specific control band associated with the parameter by programmatically contracting one or more of the control limits for the control band to exclude the off-nominal test results from the control band. Test results confirmed as nominal can be used to reinforce the nominal model during the training phase with additional examples of nominal events.

FIG. 3 is a schematic diagram depicting additional features of testing computing system 120 of FIG. 1. As previously described with reference to FIG. 1, testing computing system 120 includes logic subsystem 124, data storage subsystem 128, and input/output subsystem 132.

Logic subsystem 124 can include one or more processor devices configured to execute instructions 322 and/or process data 350 stored by data storage subsystem 128. As shown schematically in FIG. 3, data storage subsystem 128 has instructions 322 stored thereon that are executable by logic subsystem 124 to implement the various methods, processes, operations, workflows, and other techniques disclosed herein.

Instructions 322 can include a program suite 340 of one or more programs or program components. As an example, testing program suite 340 can include an evaluation component 342 that is executable by logic subsystem 310 to perform pre-processing of data at 212 and the testing phase 220 of FIG. 2A. As another example, testing program suite 340 can include a modeling component 344 that is executable by logic subsystem 310 to perform the training phase 222 of FIG. 2A to generate or update a nominal model and provide comparison information for review by users. Testing program suite 340 can further include additional components 346 that are executable by logic sub system 310 to provide additional functionality described herein. In an example, program suite 340 or components thereof can be defined or otherwise described in a programming language, such as Python or other suitable language. Evaluation component 342, modeling component 344, and other components of program suite 340 can take the form of one or more computer executable scripts, for example. An output of program suite 340, upon execution by a computing system, can take the form of one or more data files having a predefined data format, such as JavaScript Object Notation (JSON) or other suitable format, as an example.

Evaluation component 342 can include one or more computer executable instruction modules that perform preprocessing of data streams at 212 and the testing phase 220 of FIG. 2A, including a pre-processing module 372 that performs preprocessing of data streams at 212 including decoding, filtering, demultiplexing, etc. to obtain pre-processed data 214 for each parameter of a test or training subject, a processing module 374 that compares pre-processed data 214 to the deployed nominal model (e.g., 226, 238, etc.) at 224 for each parameter of the test subject to generate a comparison result, and one or more alerts modules 376 that selectively generate test results 230 (including alerts) at 228 for each parameter of the test subject.

Alerts modules 376 can support the various types of alerts described herein, including control chart alerts 380 that can be used to identify off-nominal events that include deviations from nominal unimodal, continuous, ordinal data; phase-space control chart alerts 382 that can be used to identify off-nominal events that include deviations from the nominal multimodal phase space; C-Chart alerts 384 that can be used to identify off-nominal events that include deviations in counts of enumerated (categorical) data values; and sequential rule alerts 386 that can incorporate test data from different parameters to determine whether a set of consequents are present in the test data for a given set of antecedents.

Modeling component 344 can include one or more modules that perform the training phase 222 of FIG. 2A, including a statistics module 388 that determines one or more statistics 234 for each parameter based on pre-processed data 214 of a training subject at 232, a modeling module 390 that generates nominal models (e.g., 238) at 236, a comparison module 392 that generates change information 240 at 236 for newly generated nominal models in relation to existing nominal models, pattern mining module 394 that can identify patterns of value transitions within training data for symbol coding, a rule mining module 396 that can identify sequential rules of antecedents and consequents within data of an individual parameter or across two or more parameters, and a machine-learning module 398 that can assist in generation and refinement of nominal models based on training data. As examples, modeling module 390 can utilize or incorporate machine-learning module 398 to programmatically define features of the nominal models, including determining control limits, sampling windows, rules, conditions, and other features of the nominal models, as described in further detail herein. In at least some examples, programmatic refinement of the nominal model can be performed, at least in part, by machine-learning module 398 responsive to one or more improved (e.g., optimized) features 399. Such improved features 399 can be user defined via user input (e.g., user input data 216 of FIG. 2A or user input data 294 of FIG. 2B) provided to the testing system via terminals 118, as an example.

Data 350 stored in data storage subsystem 320 can include one or more nominal models 352 (e.g., 226 and 238 of FIG. 2A), pre-processed test/training data 354 (e.g., pre-processed data 214 of FIG. 2A) for one or more test and/or training subjects, processed test data 356 (e.g., data representing comparisons of test data to nominal models obtained at 224 of FIG. 2A) for one or more test subjects, test results data 358 (e.g., 230 of FIG. 2A) for one or more test subjects, statistics data 360 (e.g., 234 of FIG. 2A) for one or more training subjects, change information data 362 (e.g., 240 of FIG. 2A) for one or more nominal model comparisons, and other suitable data 364, which can include labels (e.g., indicating nominal events and/or off-nominal events), user preferences, and settings, as examples. Within FIG. 3, data 364 including one or more labels can be associated with or otherwise applied to one or more of pre-processed test/training data 354, processed test data 356, and/or test results 358.

FIGS. 4A and 4B are flow diagrams depicting features of an example testing method 400 that can be performed by testing system 100 of FIG. 1 with respect to a test subject. As an example, the test subject can refer to electro-mechanical test subject 110 of FIG. 1, such as aircraft 112. Method 400 can be performed by testing computing system 120 executing evaluation component 342 of FIG. 3 as part of the testing phase 220 of FIG. 2A.

At 410, the method includes receiving a set of data streams from a set of sensors associated with the test subject. As indicated at 412, each data stream can represent a time-based series of measurements of either an ordinal parameter 414 or a categorical parameter 416 of the test subject. For example, each sensor of a plurality of sensors associated with the test subject can output at least one data stream representing measurements captured by that sensor in which some sensors measure ordinal parameters and some sensors measure categorical parameters.

As described herein, an ordinal parameter refers to a parameter category for which a range of potential values for the parameter have a particular order within that range. As an example, a measured electrical current generated by a battery can have a range of values from 0 amps to 15 amps within which a measured value of 5 amps is located between the values of 0 and 15 amps. By contrast, a categorical parameter, as used herein, refers to a parameter category for which a range of potential values for the parameter do not have a particular order within that range. As an example, an electrical switch can have two states corresponding to an open state represented by the value “0” and a closed state represented by the value “1”. The two states of this example do not have a particular order within the potential states, and thus refers to a categorical parameter.

In at least some examples, the data streams received at 410 can be pre-processed as previously described at 212. Such data streams can include parameter identifiers at specific locations within data frames as specified by the particular encoding and communications protocol or standard. These parameter identifiers can be used by the testing system to filter, separate, and organize data for each parameter of the test subject.

In at least some examples, the method at 420 can include identifying an initiating event with respect to the test subject. As an example, the initiating event can refer to a power-on event of some or all electronic components of the test subject. However, other initiating events can be identified by the testing system, such as user inputs or control inputs or outputs of the training subject, as examples. By identifying an initiating event at 420, parameters of the test subject associated with time-based sequences following the initiating event can be analyzed more effectively by associating measured values for those parameters with timing values representing a relative timing of the measured values relative to the initiating event. This association of measured values with a relative timing with respect to the initiating event can increase processing efficiency by enabling targeted searching for predefined values and sequences of value transitions within the data streams.

At 430, the method includes storing each data stream in a data storage device. As previously described with reference to FIG. 2A, storing of each data stream at 430 can include buffering the data stream in a data storage subsystem from which data can be selectively retrieved and processed. In at least some examples, each data stream can be stored in association with a parameter identifier and/or timing values indicating a relative timing of the time-based series of measurements of the data stream relative to the initiating event. Parameter identifiers can be extracted from the data streams as part of the pre-processing performed at 212 of FIG. 2A. The storing of the data streams at 430 can be within storage subsystem 128 of the testing computing system as pre-processed test/training data 354 of FIG. 3.

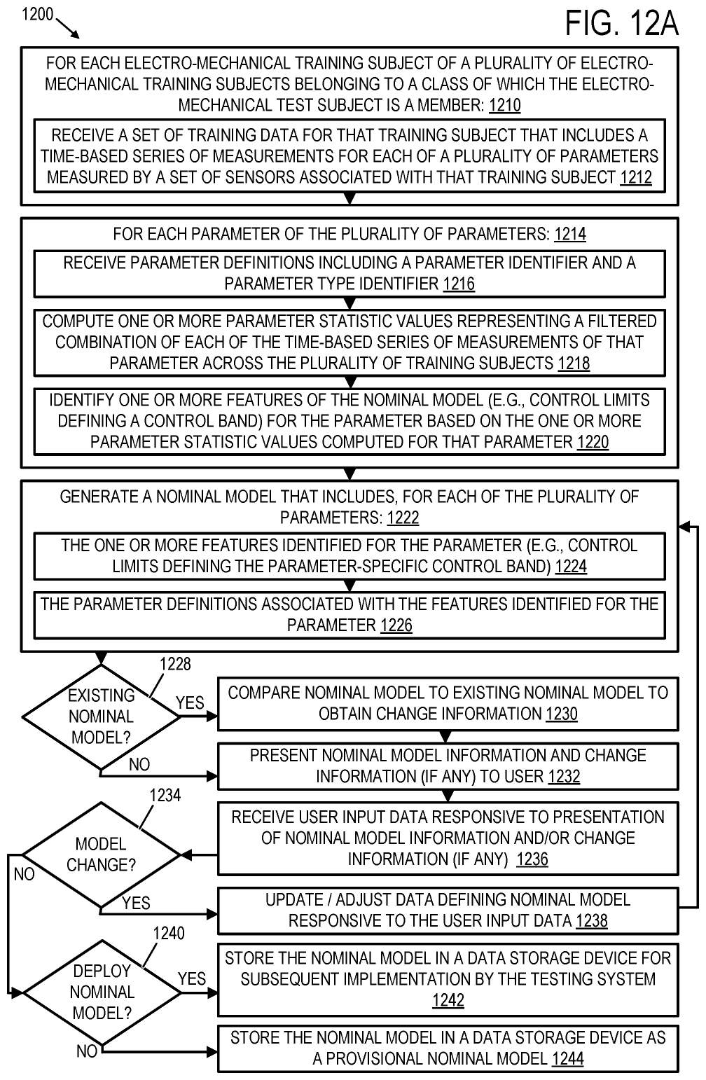

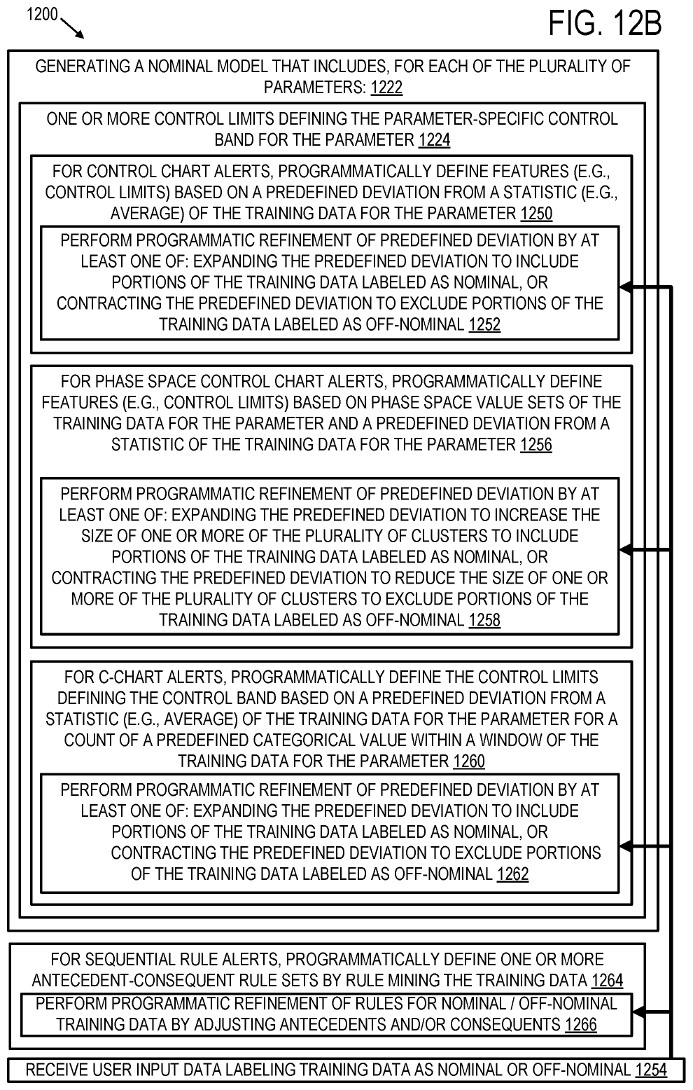

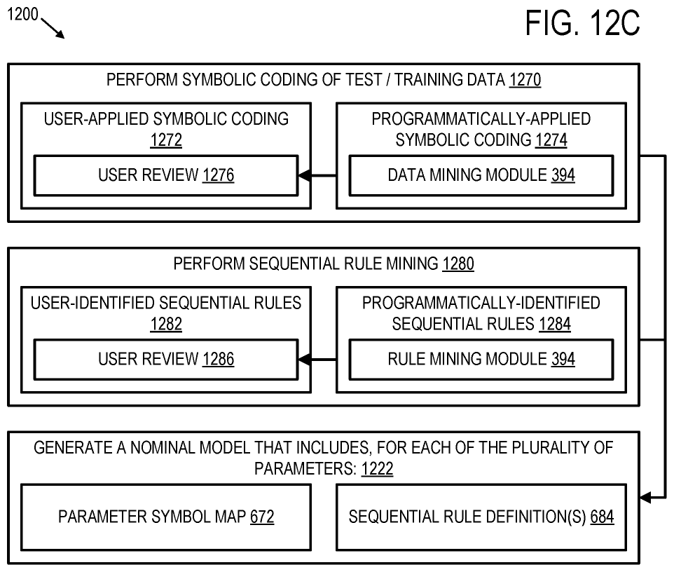

At 432, the method includes obtaining a nominal model for the test subject. As an example, the nominal model obtained at 432 can refer to previously described nominal models of FIGS. 2A, 2B, and 3. In at least some examples, the nominal model defines a parameter-specific control band for each parameter of the test subject. One or more control limits of the nominal model can define each parameter-specific control band such that each control band can have a different set of control limits from other parameters of the test subject. Such control limits can be identified through training of the nominal model on previously received training data for one or more electro-mechanical training subjects belonging to a class of which the test subject is a member. The nominal model obtained at 432 can alternatively or additionally include a set of sequential rules against which the test data can be compared to determine whether the test data includes nominal or off-nominal events. Features of an example nominal model are described in further detail with reference to FIG. 6, and an example method for training a nominal model is described in further detail with reference to FIGS. 12A-12C.

At 440, the method includes processing the data streams of the test data in combination with the nominal model to generate one or more test results. As part of the processing performed at 440, the method at 442 can include, for each data stream, selecting a predefined, parameter-specific control band of the nominal model. In at least some examples, each parameter-specific control band can be associated with a parameter identifier within the nominal model. The parameter-specific control band can be selected from a plurality of control bands of the nominal model by referencing a parameter identifier associated with the data stream at 430 and matching that parameter identifier with the parameter identifier associated with the control band within the nominal model.

As part of the processing performed at 440, the method at 444 can include for each data stream, identifying the time-based series of measurements of that data stream as being an ordinal parameter or a categorical parameter based, for example, on the parameter identifier associated with the data stream. In at least some examples, the nominal model can include one or more parameter definitions for each parameter of the test subject, including a parameter type identifier that identifies the parameter as being either an ordinal parameter or a categorical parameter. The testing computing system can reference these parameter definitions within the nominal model as part of operation 444. Parameter definitions will be described in further detail with reference to FIG. 6.

As part of the processing performed at 440, for each data stream identified as an ordinal parameter 446, the method at 450 can further include comparing the time-based series of measurements of the ordinal parameter to the control band selected for the ordinal parameter to identify any of the time-based series of measurements that exceed the control band for the ordinal parameter.

In at least some examples, the parameter-specific control band for one or more of the plurality of parameters can be a time-varying control band relative to the initiating event identified at 420. As an example, one or more control limits of the control band can be defined as varying over time (increasing and/or decreasing) relative to the initiating event. As part of the comparing operation performed at 450, the method can include comparing the time-based series of measurements of the one or more parameters relative to the initiating event (e.g., the measured value at 5 seconds after the initiating event) to a time-aligned portion of the time-varying control band for the parameter relative to the initiating event (e.g., the control limits of the time-varying control band at 5 seconds).

As part of the processing performed at 440, for each data stream identified as an ordinal parameter 446, the method at 452 further includes selectively generating an ordinal parameter output as part of the test results responsive to whether a condition is satisfied with respect to any of the time-based series of measurements of the ordinal parameter exceeding the control band for the ordinal parameter. As an example, the ordinal parameter output can include test results 230 (e.g., alerts) and test results data 358 previously described with reference to FIGS. 2A, 2B, and 3.

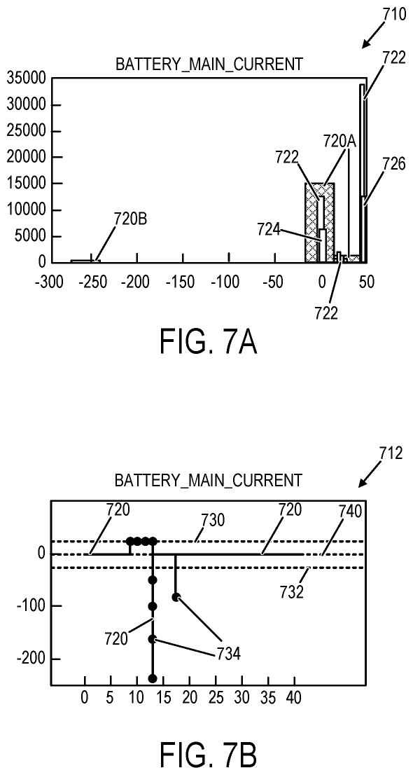

In a first example, referred to as a control chart alert (e.g., 380 of FIG. 3), the test result that is generated at 452 can indicate an off-nominal event with respect to the ordinal parameter responsive to the condition of one or more of the time-based series of measurements exceeding the control band. FIGS. 7A and 7B depict an example of test data associated with a control chart alert.

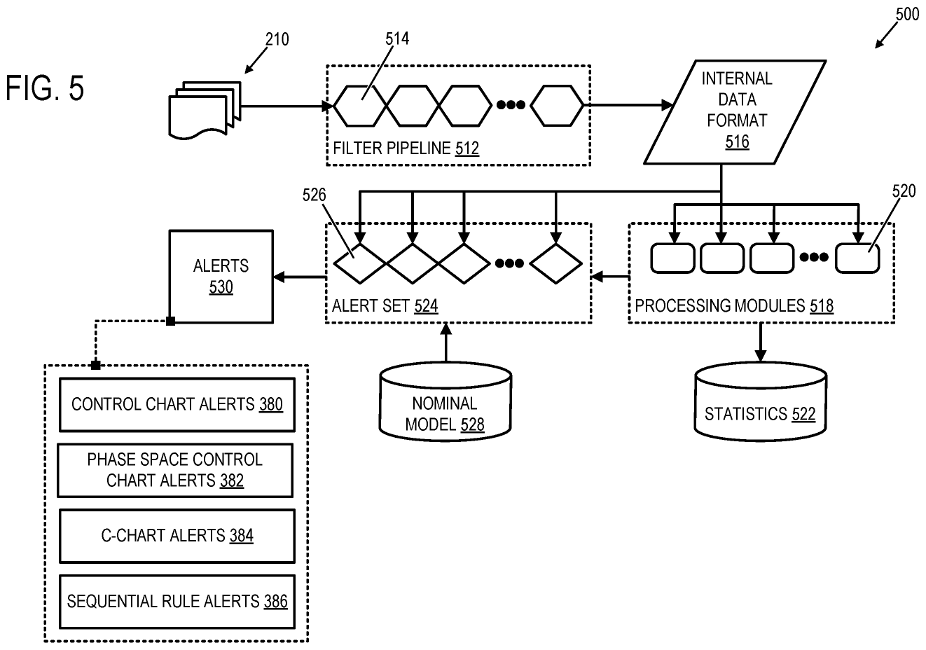

In a second example, referred to as a phase space control chart alert (e.g., 382 of FIG. 3), a phase space value set can be determined by the testing computing system for each of the time-based series of measurements. For example, statistics 522 of FIG. 5 can include phase space value sets determined for each measurement in the time-based series. The phase space value set for a current value of the time-based series of measurements can be defined as having a first value corresponding to a previous value in relation to the current value in the time-based series of measurements, and a second value corresponding to a difference between the current value and the previous value. As part of operation 450, the method can further include comparing the phase space value sets to the parameter-specific control band as one of a plurality of clusters of phase space value sets. As part of operation 452, the test result that is generated can indicate an off-nominal event with respect to the ordinal parameter responsive to the condition of any of the phase space value sets exceeding each of the plurality of clusters of the phase space value sets. However, the condition applied at 452 can alternatively provide that a threshold quantity greater than one phase space value set exceeds each of the plurality of clusters to indicate an off-nominal event. In these examples, the clusters take the form of the control limits defined by the nominal model.

As part of the processing performed at 440, for each data stream identified as a categorical parameter 448, the method at 460 includes identifying a quantity (or a proportion to the total quantity of sampled values in the window) of a particular categorical value of the time-based series of measurements that exceed a control limit of the control band within a sampling window defined by the condition of the nominal model. As an example, a sampling window of 10 seconds can be defined by the nominal model with respect to counting instances of the value “0” representing an open state of a switch or instances of the value “1” representing a closed state of the switch, and the control band can be defined by an upper control limit of one or more instances of the categorical value being present within the sampling window.

As part of the processing performed at 440, for each data stream identified as a categorical parameter 448, the method at 462 can further include comparing the quantity (or proportion) of the categorical value of the categorical parameter to the control band selected for the categorical parameter.

As part of the processing performed at 440, for each data stream identified as a categorical parameter 448, the method at 464 can further include selectively generating a categorical parameter output as part of the test results responsive to whether the quantity (or proportion) of the categorical values exceeds the control band for the categorical parameter. As an example, the test result that is generated at 464 can indicate an off-nominal event with respect to the categorical parameter responsive to the quantity (or proportion) of categorical values identified at 460 exceeding the control limit of variable N values within the sampling window. These types of alerts for categorical parameters can be referred to as C-chart alerts (e.g., 384 of FIG. 3).

Referring also to FIG. 4B, as part of the processing performed at 440 of method 400, the testing system can attempt to identify a set of one or more antecedents in the test data at 470. Each antecedent can refer to a particular transition of a measured value of a parameter within a particular one of the plurality of data streams. Antecedents of the set identified at 470 can incorporate test data from one, two, or more parameters, in at least some examples. Accordingly, antecedents can define inter-parameter transitions to be identified within the test data.

At 472, the testing system can attempt to identify a set of one or more consequents associated with the set of antecedents that subsequently occur within the text data. Each consequent can refer to a particular transition of a measured value of a parameter within a particular one of the plurality of data streams. Consequents of the set identified at 472 can incorporate test data from one, two, or more parameters, in at least some examples. Accordingly, consequents can define inter-parameter transitions to be identified within the test data.

At 474, the testing system can selectively generate a sequential rule output as part of the test results responsive to identifying the set of one or more consequents subsequent to the set of one or more antecedents in the test data. As an example, the testing system can output an indication of an off-nominal event if the consequents are not identified in the test data following identification of the set of antecedents.

The various test results generated at 440 can be stored in the data storage subsystem of the computing system at 476 and/or output at 478 via one or more terminals 118. As an example, the test results output at 478 can include presenting the test results 480 to one or more users 116.

At 482, a user interface (e.g., 292 of FIG. 2B) for the test results can be presented to users 116 via terminals 118, and user input data (e.g., 216 of FIG. 2A or 294 of FIG. 2B) can be received at 484 with respect to the test results via the user interface.

At 486, responsive to the user input data received at 484 indicating that the test results for one or more parameters represents a nominal event, the test data for the one or more parameters can be labeled as representing a nominal event at 488. As previously described with reference to FIG. 2B, the user input data can either confirm a nominal event identified within test results as representing a nominal event or identify the nominal event identified within the test results as instead representing an off-nominal event. Additionally, at 486, responsive to the user input data received at 484 indicating that the test results for one or more parameters represents an off-nominal event, the test data for the one or more parameters can be labeled as representing an off-nominal event at 490. The labeling performed at 488 and/or 490 creates labeled test data 489. In at least some examples, user input data may not be received with respect to some or all of the test results at 484. Portions of the test results for which a user input data is not received at 484 can refer to unlabeled test data at 492.

At 494, the labeled 489 and/or unlabeled 490 test data can be provided to the modeling component 344 of FIG. 3 (including one or more of its modules—e.g., machine-learning module 398) to train or retrain the nominal model with the test data as training data for the training phase 222 of FIG. 2A, including any labels applied at 488 and/or 490 to generate an updated nominal model. In at least some examples, labels applied at 488 and/or 490 can be used to filter the training data such that only a subset of the training data labeled as either nominal or off-nominal is incorporated into the updated nominal model. Furthermore, in at least some examples, labels applied at 488 and/or 490 can be used as ground truth data as part of supervised training of a machine-learning model (e.g., of machine-learning module 398 of FIG. 3) that refines and generates the updated nominal model.

Referring again to FIG. 4A, in at least some examples, the process flow can return to 410 from 430 and/or 440 to provide continuous, real-time or near-real-time monitoring and testing of test subjects. As an example, test results can be generated at 440 and output at 478 while the set of data streams are being received at 410 to provide real-time or near-real-time monitoring and testing of a test subject.

FIG. 5 is a flow diagram depicting features of an example workflow with respect to the testing phase 220 of FIG. 2A. The features of FIG. 5 can form part of evaluation component 342 of FIG. 3, as an example. Data streams 210 received from test subjects are received and pre-processed by a set of streaming filters 514 of a filter pipeline 512 as part of the pre-processing of data streams performed at 212 of FIG. 2A to obtain the data streams formatted according to an internal data format 516 of processed data 214 of FIG. 2A. The set of streaming filters 514 can form part of pre-processing module 372 of FIG. 3.

A set of processing modules 518 of which processing module 520 is an example can determine or otherwise compute statistics 522 for the internal data format 516 of the pre-processed test data. Statistics 522 can be used as part of comparing the test data to the nominal model, such as described at 224 of FIG. 2A. Statistics 522 can include any of the previously described statistics 234 of FIG. 2A. Statistics 522 can additionally or alternatively include phase space value sets computed for ordinal parameters as described herein. As an example, a minimum measured value and a maximum measured value of a parameter can be determined as part of statistics 522, which can be compared to the nominal model to determine whether the minimum measured value exceeded a parameter-specific control band for the parameter.

The test data and statistics 522 can be provided to a set of alert modules 524 of which alert module 526 is an example. Alerts modules 524 can include a subset of available alert modules 376 of FIG. 3. Alerts 530 can be selectively triggered by the set of alerts modules 524 based on the comparison of the internal format data 516 of the test data and statistics 522 to alert definitions defined by nominal model 528. In this example, the set of alerts modules 524 rely on nominal model 226, which can be selected or otherwise specified by a user via user input (e.g., a command-line input or GUI selection).

As previously described with reference to FIG. 3, alerts reported by the set of alert modules 526 can include control chart alerts 380, phase-space control chart alerts 382, C-Chart alerts 384, and sequential rule alerts depending on the types of alerts defined by the nominal model.

The filters, processing modules, and alerts modules of FIG. 5 can be implemented as components of program suite 340 of FIG. 3, and can be selectively added to or removed from evaluation component 342 by user input, thereby providing an evaluation component that is flexible to accommodate a particular type of test subject.

FIG. 6 is a schematic diagram depicting features of an example nominal model 600. Nominal model 600 is an example of previously described nominal models 226, 238, and 352 of FIGS. 2A, 2B, and 3. Nominal model 600 can take the form of data stored in data storage subsystem 128 and/or data processed by logic subsystem 124 of test computing system 120, as an example.

Nominal model 600 includes modeled parameter data 610 for a parameter of a test subject that is to be tested by testing system 100. As an example, the parameter associated with modeled parameter data 610 can refer to battery current measured with respect to a battery of the test subject. Nominal model 600 can include modeled parameter data for each of a plurality of parameters to be tested with respect to a test subject. As an example, nominal model 600 can include dozens, hundreds, thousands, or more modeled parameters. Accordingly, modeled parameter data 610 represents one example of modeled parameter data for one of a plurality of parameters of a test subject.

Modeled parameter data 610 can include set of parameter definitions 614, including a parameter identifier 616, a parameter type identifier 618, and a set of potential states 619 of the parameter. Parameter identifier 616 identifies a parameter that is modeled by modeled parameter data 610. Parameter identifier 616 enables modeled parameter data 610 to be distinguished from other sets of modeled parameter data for other parameters within nominal model 600. As an example, parameter identifier 616 can include a textual descriptor “Battery_Main_Current” identifying a battery current parameter. However, other suitable types of parameter identifiers can be used.

Parameter type identifier 618 can identify whether the parameter is an ordinal parameter or a categorical parameter, which can be used by evaluation component 342 to select a particular processing pipeline and alert type for test data received for the parameter, consistent with method 400 of FIGS. 4A and 4B, for example. Potential states 619 can identify two or more potential states that test data for the parameter can exhibit in the case of the parameter having a finite set of discrete states. As another example, potential states 619 can identify a range of states in the case of the parameter being capable of exhibiting any number of states within the range. As an example, a position of a switch having two positions can be modeled as having potential states 619 represented by a value of “1” indicating a first position of the switch and a value of “0” indicating a second position of the switch. As another example, a current of a battery can be modeled as having potential states 619 represented by a value of “0” amps indicating a lower bound of a current range and a value of “15” amps indicating an upper bound of a potential current range for the battery.

Modeled parameter data 610 can include a set of control chart alert definitions 620 for a control chart alert (e.g., 380 of FIG. 3). In at least some examples, control chart alerts can be selectively generated for test data of parameters identified as ordinal parameters using control chart alert definitions 620. Control chart alert definitions 620 can define a control band 622 as having one or more control limits 624 with respect to which test data can be compared, such as a value representing an upper control limit 626 and a value representing a lower control limit 628 of the control band. In at least some examples, only one of upper control limit 626 or lower control limit 628 can be used to define control band 622, such as where the lower control limit is bounded by zero or some other value. Upper control limit 626 and/or lower control limit 628 can be determined and set within nominal model 600 as part of the training phase 222 of FIG. 2A. As control band 622 is associated with a particular parameter within modeled parameter data 610, the control band can be referred to as a parameter-specific control band. Accordingly, other modeled parameters can be associated with different control bands within nominal model 600.

Control chart alert definitions 620 can include one or more trigger conditions 630 which are to be satisfied by test data with respect to control band 622 for a control chart alert to be generated for the parameter. As an example, test data that includes measurements of battery current can be compared to control band 622 to determine whether any of those measurements exceed upper limit 626 and/or lower limit 628 of the control band. Continuing with this example, trigger conditions 630 can define a quantity of measurement samples and/or a duration of time for which the measurements exceed the limits of control band 622 for an alert to be generated. As an example, trigger conditions 630 can specify that any measurement exceeding control band 622 is to result in a control chart alert being generated. As another example, trigger conditions 630 can specify that if greater than a particular quantity of measurement samples exceed control band 622 within a particular period of time that a control chart alert is to be generated. Accordingly, control chart alert definitions 620 provide users with flexibility to tune control band limits and/or trigger conditions on a per-parameter basis for controlling if and when a control chart alert is output by the testing system.

The use of control charts as defined, at least in part, by control chart alert definitions 620 can provide a practical and effective approach for determining if a measured value of a parameter significantly deviates from nominal statistics for that parameter. During the training phase, for example, the testing system can use the nominal mean and standard deviation for each parameter to compute upper control limit 626 and lower control limit 628 for that parameter, which can be stored in a data file representing nominal model 600 and then used by the testing system during the testing phase to produce alerts when measured values within test data fall outside of these control limits. As an example, control limits of a 3-sigma control chart can be defined as upper control limit 626 being equal to μ+3σ and lower control limit 628 being equal to μ−3σ, where μ is the nominal mean and σ is the nominal standard deviation. However, other suitable deviations from the nominal mean can be used.

The baseline control chart described above can based on an assumption of unimodal test data, where the statistics of the nominal parameter values follow a normal distribution. The use of three standard deviations to set the control limits, is equivalent to a 0.27% chance that the test system characterizes a measurement as an off-nominal deviation. However, it will be understood that other suitable values for control limits can be used. For example, if the underlying distribution does not follow a normal distribution, the likelihood of exceeding the upper or lower control limits could change (e.g., can be either larger or smaller than 0.27%), depending on the particular distribution. Modeling component 344 of FIG. 3 can be used to programmatically identify a suitable deviation from the nominal mean based on a set of training data received from one or more training subjects.

Referring also to FIGS. 7A and 7B, example control charts 710 and 712 that can be output by the testing system as part of generating control chart alerts are shown. These control charts can be generated by evaluation component 342 of FIG. 3, as an example. For example, control charts 710 and 712 shown in FIGS. 7A and 7B, respectively, can be presented by the testing system to a user via a graphical display associated with a computer terminal.

In this example, control chart alerts provide an indication of a detected battery charging fault as an example of an off-nominal event. FIG. 7A, for example, shows the battery charging fault in graphical form as a histogram view of the test data, representing measured battery current identified as “BATTERY_MAIN_CURRENT”. FIG. 7B shows examples of an upper control limit 730 and a lower control limit 732 with respect to the test data of FIG. 7A indicated at 720.

Within FIG. 7A, quantities of individual measurements are depicted along the vertical axis and the measured current is depicted along the horizontal axis. In this example, measured current was obtained from three different subjects whose data is indicated at 720A, 722, and 724 as being within control limits. At least some of test data 720B of the same test subject from which test data 720A was received is located outside of control limits 730 and 732, representing an off-nominal event.

Within FIG. 7B, individual measured values of data 720 (including data 720A and 720B of FIG. 7A) that are located outside of control limits 730 and 732 are depicted at 734. As an example, upper limit control limit 730 and lower control limit 732 can be defined based on a predefined deviation (e.g., a standard deviation) from an average battery current 740 measured within training data received from training subjects.

Returning to FIG. 6, modeled parameter data 610 can include a set of phase space control chart alert definitions 640. In at least some examples, phase space control chart alerts can be selectively generated as test results for test data of parameters identified as ordinal parameters using phase space control chart alert definitions 640. Although the control charts and control chart alerts, described with reference to control chart alert definitions 620 and FIGS. 7A and 7B, can be effective at providing anomaly detection within test data, these control charts can be further improved or otherwise augmented by modeling the dynamics of parameter value changes in test data using a phase space representation and by relaxing the unimodal distribution assumption of the control charts to model multimodal data.

In at least some examples, during the training phase 222, a phase space can be identified for each individual parameter based on a difference determined between a previous measured value and a current measured value within the test data as compared to the previous measured value. For example, this phase space can be plotted for each measured value within a series of measured values of test data by using a first variable defined as the previous value that represents the variable “x” with a two-dimensional graph and a second variable defined by the difference between the current measured value and the previous measured value that represents the variable “y” within the two-dimensional graph. These x, y points within the two-dimensional graph can be clustered into N clusters using a Gaussian Mixture Model (GMM) or other suitable technique. GMM, for example, is characterized by centroids and covariance matrices for each cluster. These centroids and covariances can be saved to nominal model 600 as cluster definitions 642 and used to produce alerts on new test data during the testing phase. Because new data points can fall within one of the N clusters, the unimodal assumption of the previously described control charts provided by definitions 620 can be referred to as being relaxed in the phase space control charts provided by definitions 640.

In at least some examples, the cluster centroids and covariance matrices can be used to compute a T² test statistic for a new incoming phase space point that is received during testing (e.g., (previous value, current value−previous value) within the (x, y) two-dimensional framework discussed above). The T² test statistic can be compared to an upper control limit 644 of one or more control limits 646 of control band 648 of definitions 640. In an example, upper control limit 644 can be programmatically determined during the training phase 222 according to a Beta distribution. In this example, an alert is generated by the testing system if the T² test statistics for each of the N clusters are larger than upper control limit 644—i.e., the new phase space point does not belong in any of the nominal phase space clusters (the N clusters).

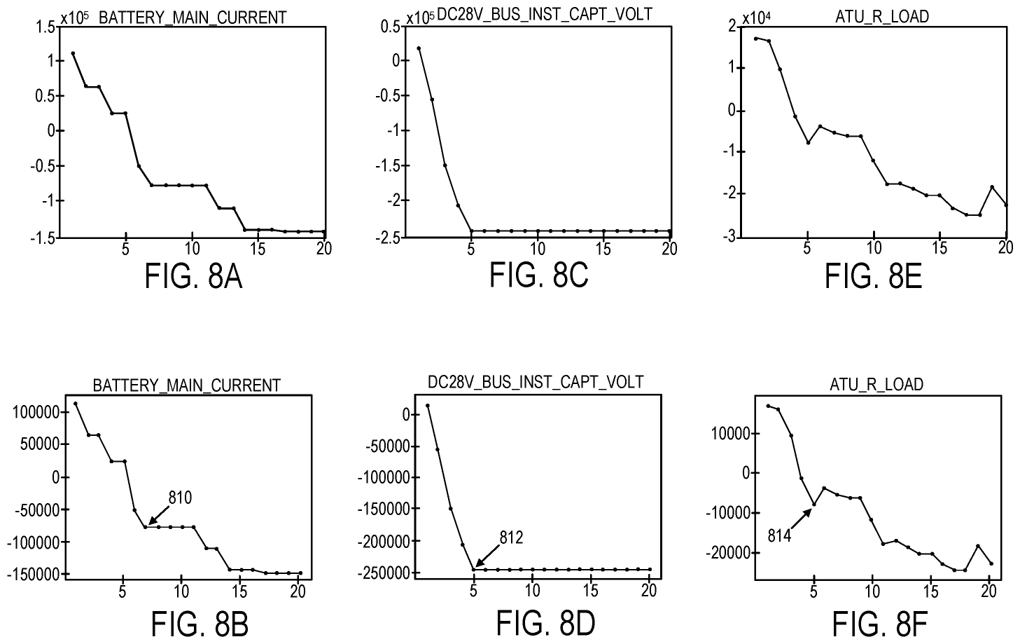

In at least some examples, the number of GMM components, N, can be programmatically selected using criteria such as the Akaike information criterion (AIC) or the Bayesian information criterion (BIC). These criterion attempt to balance model complexity with how well the model fits the data, where both of these quantities increase as N increases. FIGS. 8A-8F show curves which result from plotting AIC/BIC on the y-axis and increasing the value of N on the x-axis for three different parameters: Battery_Main_Current (FIGS. 8A and 8B), DC28V_Bus_Inst_CaptP_Volt (FIGS. 8C and 8D), and ATU_R_Load (FIGS. 8E and 8F). In at least some examples, a target N can be programmatically selected by modeling component 344 determining the first (from the left indicating the lower-side of GMM) local minimum of these curves. The bottom row of FIGS. 8B, 8D, and 8F show an example of the target number of GMM components using the local minimum criterion for each of the data sets shown in the upper row of FIGS. 8A, 8C, and 8E, respectively. For example, FIG. 8B shows a number (N) of 7 GMM components for Battery_Main_Current, FIG. 8D shows a number of 5 GMM components for DC28V_Bus_Inst_CaptP_Volt, and FIG. 8F shows a number of 5 GMM components for ATU_R_Load.

Clustering methods other than GMM can used, such as Hierarchical Density-Based Spatial Clustering of Application with Noise (HDB SCAN) as an example, which has the potential to better approximate linear clusters which are found in the phase space of some CDN parameters. The use of AIC/BIC criterion to select the number of GMM components in the above examples can be unsupervised. If there exists both nominal and off-nominal data, selection of the number of GMM components can be further improved with supervised methods, such as by labeling of nominal and off-nominal events by users. Improving (e.g., optimizing) the number of GMM components can rely on supervised classification methods utilizing data designated (e.g., labeled) as nominal and off-nominal.

Phase space control chart alert definitions can include one or more trigger conditions 650 that define a threshold quantity of data points residing outside of the clusters defined by cluster definitions 642 that generate a test result indicating an off-nominal event.

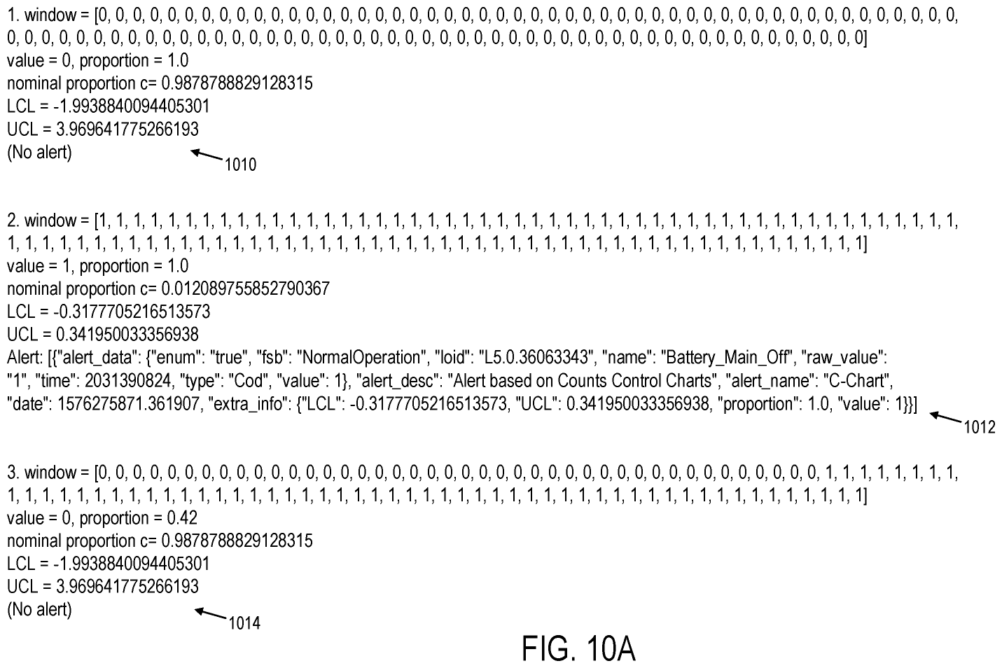

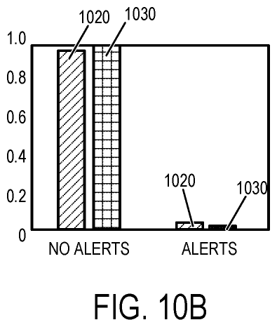

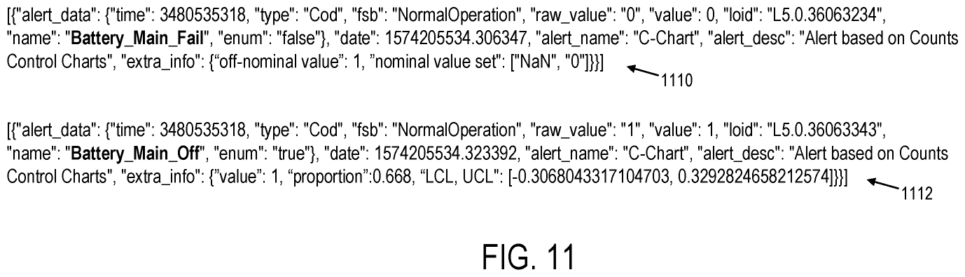

Modeled parameter data 610 can include one or more C-chart alert definitions 660 that include a given measured value identified by value definition 662, a window size 664 for which that given measured value is to be counted by the testing system, and one or more trigger conditions 670 that define, as an example, a threshold quantity of those given measured values within the window size for which an off-nominal event is to be indicated within the test results by an alert. Window size 664 can include a time period 666 (i.e., a duration of time) or a sample quantity 668 representing a number of measured value samples. Examples of C-chart alerts that can be generated by the testing system based on C-chart alert definitions 660 are described in further detail with reference to FIGS. 10A, 10B, and 11.

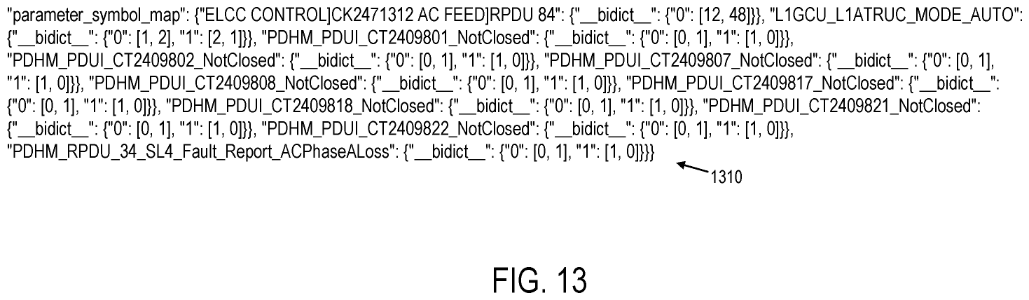

Modeled parameter data 610 can include a parameter symbol map 672 that includes one or more encoded value transitions, an example of which is encoded value transition 674. Each encoded value transition encodes one or more transitions between measured values with a symbol. As an example, encoded value transition 674 is defined by a symbol 676 that encodes value sequence 678 representing a transition from a first measured value 680 “VALUE_1” to a second measured value 682 “VALUE_2” within a data stream of measured values for a parameter. An example symbol map for a parameter is described in further detail with reference to FIG. 13. Symbols associated with parameter transitions can be used to define sequences of transitions that are nominal or off-nominal using sequential rule definitions 684.

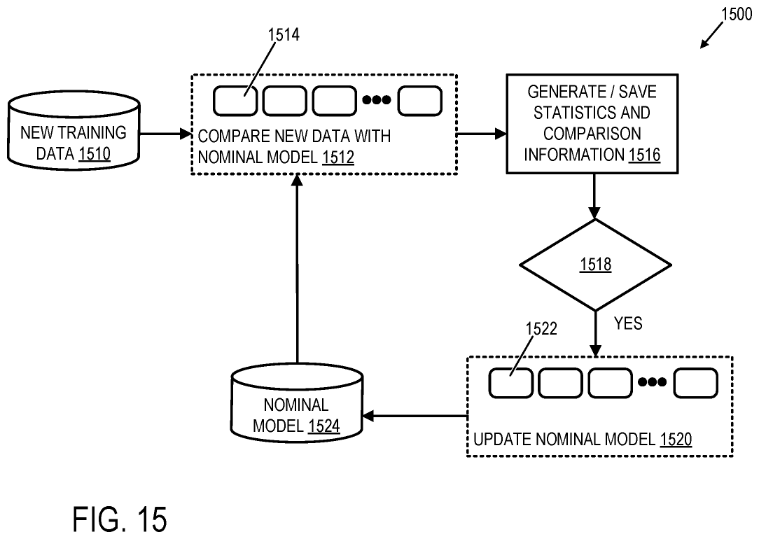

Modeled parameter data 610 can include one or more sequential rule definitions 684 that rely upon parameter symbol map 672 of one or more modeled parameters. Each sequential rule definition can include one or more antecedents 686 of one or more antecedent symbols 688 that are linked to one or more consequents 690 of one or more consequent symbols 692. The testing system can apply sequential rule definitions 684 by attempting to identify the one or more antecedent symbols 688 for each antecedent within data streams of test data for a test subject, and upon identifying the antecedent, attempting to identify the one or more consequent symbols 692 subsequently occurring with the data streams of the test data to the one or more antecedent symbols 688. Upon identifying both the one or more antecedent symbols 688 and the one or more associated consequent symbols 692, a nominal or off-nominal event is identified within the test data and a test result can be generated by the testing system based on one or more trigger conditions 694 associated with the identification of the antecedent-consequent set. Antecedent symbols 688 and consequent symbols 692 can include any symbol defined by a parameter symbol map of the nominal model, such as symbol 676. Trigger conditions 694 can identify whether identification of the antecedent-consequent set in the test data generates a nominal or an off-nominal test result. Example sequential rule definitions are described in further detail with reference to FIGS. 15A and 15B.

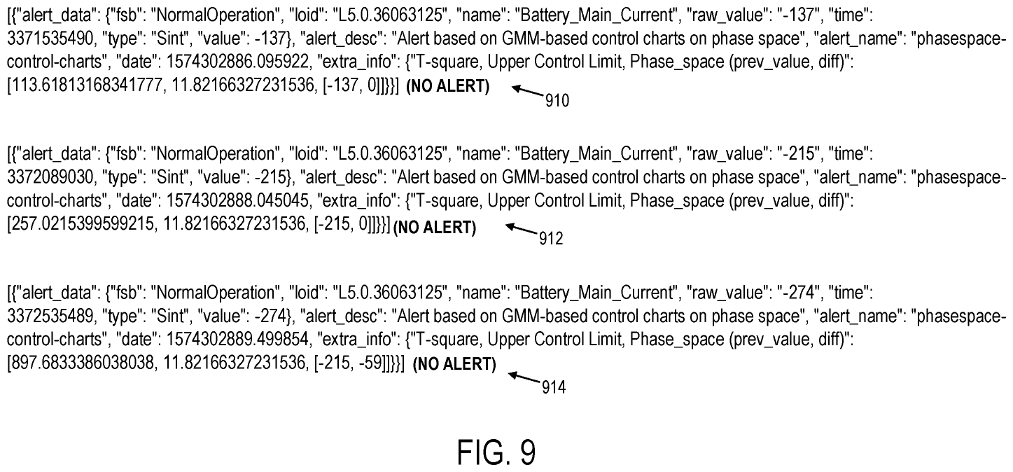

FIG. 9 shows example test results 910, 912, and 914 for an ordinal parameter “Battery_Main_Current” of a battery of an example test subject at three instances in time. In this example, test results 1010, 1012, and 1014 refer to an output associated with phase space control chart alerts that can be generated by evaluation component 342 of FIG. 3. In this particular example, test results 910, 912, and 914 do not include an indication of an alert, because the T² values of the test data did not exceed the control limits defined by the phase space clusters. Test results 910, 912, and 914 can be output via a GUI of a computer terminal, as an example.

FIG. 10A shows example test results 1010, 1012, 1014 for the categorical parameter “Battery_Main_Off” of an example test subject. In this example, test results 1010, 1012, and 1014 refer to an output associated with C-chart alerts that can be generated by evaluation component 342 of FIG. 3. In this particular example, test result 1012 includes an indication of an alert for the parameter Battery_Main_Off, because the proportion 1.0 of the measured categorical value “1” to other categorical values for the categorical parameter within the applicable window exceeded the upper control limit (UCL) of 0.34195. Accordingly, test data 1012 indicates a C-chart alert. By contrast, the proportion of measured categorical value “1” to other categorical values in test data 1010 and 1014 did not exceed either the UCL or the lower control limit (LCL) within the applicable window. Accordingly, test data 1010 and 1014 do not indicate a C-chart alert. Test results 1010, 1012, and 1014 can be output via a GUI of a computer terminal, as an example.

Within the examples of FIG. 10A, for test data 1010 and 1014, the applicable windows of data applied to a test subject fall under the first case (no alert), which is expected since the test subject in this example was previously used as a training subject to generate the nominal model. One goal for selecting the applicable window size for a parameter can be to eliminate or reduce (e.g., minimize) the number of alerts generated on nominal data, which can be achieved in at least some examples by increasing the window size. For example, FIG. 10B shows the proportions of alerts and no alerts with two different window sizes 1020 and 1030. For window size 1020 which is set to 100 samples or time units, the proportion of alerts is 1.10%. For window size 1030 which is set to 1000 samples or time units, the proportion of alerts is reduced to 0.15%.

FIG. 11 shows example test results 1110 and 1112 for the categorical parameters “Battery_Main_Fail” and “Battery_Main_Off” of an example test subject. In this example, test results 1110 and 1112 indicate alerts of an off-nominal event associated with a battery charging error representing off-nominal events. In test results 1112, for example, the proportion of counts having a value “1” within the applicable window exceed the UCL of 0.329. Accordingly, test results 1112 indicates an alert of the off-nominal event with respect to the test subject.

FIGS. 12A, 12B, and 12C are flow diagrams depicting features of an example training method 1200 that can be performed by testing system 100 of FIG. 1 with respect to one or more training subjects. As an example, a training subject can refer to electro-mechanical test subject 110 of FIG. 1, such as aircraft 112. Method 1200 can be performed by testing computing system 120 executing modeling component 344 of FIG. 3 as part of the training phase 222 of FIG. 2A.

At 1210, for each electro-mechanical training subject of a plurality of electro-mechanical training subjects belonging to a class of which the electro-mechanical test subject is a member, the method at 1212 includes receiving a set of test data for that training subject that comprises a time-based series of measurements for each of a plurality of parameters measured by a set of sensors associated with the training subject. The set of training data received for each training subject can be stored in a data storage device (e.g., a data storage subsystem 124) as part of operation 1212. As an example, the training data can be pre-processed as previously described with reference to operation 214 of FIG. 2A, and can take the form of data 354 of FIG. 3.

At 1214, for each parameter of the plurality of parameters, the method at 1216 includes receiving one or more parameter definitions for the parameter, including a parameter identifier and a parameter type identifier. As an example, parameter definitions 614 of nominal model 600 include parameter type identifier 618. In at least some examples, parameter type identifier 618 can be associated with the nominal model by a human user during construction of the model. For example, human user 116 of FIGS. 1 and 2A can operate a terminal 118 to label each parameter as being a categorical or an ordinal parameter by providing user input (e.g., 216 of FIG. 2A or 294 of FIG. 2B).

At 1214, for each parameter of the plurality of parameters, the method at 1218 includes computing one or more parameter statistic values representing a filtered combination of each of the time-based series of measurements of that parameter of each of the plurality of training subjects. The parameter statistic values can refer to statistics 234 of FIG. 2A, as an example. The filtered combination can take the form of any suitable combination of training data for each parameter of a plurality of training subjects. As an example, a filtered combination can refer to an average value or other suitable statistic for each parameter of the plurality of training subjects.

At 1214, for each parameter of the plurality of parameters, the method at 1220 includes identifying one or more features of the nominal model for the parameter based on the one or more parameter statistic values computed for that parameter. Features identified at 1220 can include control limits of the control band, cluster size and/or quantity (e.g., for phase space control chart alerts), sampling window size (e.g., for categorical parameters), conditions, and/or rules. As previously described with reference to FIG. 6, these features can be used to define aspects of the various alerts described herein. For example, a predefined deviation (e.g., standard deviation) from an average measured value of the parameter can be used to programmatically determine and set the control band and control limits for at least some of the alerts.

In at least some examples, pattern mining module 394, rule mining module 396, and/or machine-learning module 398 of the testing system can be used to programmatically define one or more features of the nominal model. In the case of machine-learning module 398, for example, improved (e.g., optimized) features (e.g., 399) defined by user input data can be used to update the nominal model to comply with those improved features. Furthermore, in at least some examples, a human user can adjust features of the nominal model that are programmatically generated by the testing system (e.g., by increasing or decreasing one or more of the control limits from the programmatically defined value) to a different value to thereby increase or decrease a quantity of alerts generated by the nominal model.

At 1222, the method includes generating a nominal model that includes, for each of the plurality of parameters, the one or more features identified for the parameter at 1220. As an example, one or more limits defining the parameter-specific control band for the parameter can be included in the nominal model generated at 1224. In at least some examples, generating the nominal model at 1222 additionally includes for each of the plurality of parameters, at 1226, the parameter definitions received at 1216 associated with the parameter-specific control band for the parameter. For example, nominal model 600 of FIG. 6 associates the various features (e.g., parameter-specific control bands) with parameter definitions 614.

Referring also to FIG. 12B, as part of generating the nominal model at 1222 and 1224, the control limits for each of the plurality of parameters can be at least initially programmatically defined by the testing system. These programmatically defined control limits can serve as a starting point for model development and training of the nominal model. As an example, the programmatically defined control limits can provide proposed control limit values that can be subsequently adjusted by a human user. Other features of the nominal model can also be programmatically defined by the testing system, including sampling window size for C-chart alerts and antecedent-consequent combinations for sequential rule alerts.

For control chart alerts, at 1250 the method can include programmatically defining the control limits of the control band based on a predefined deviation (e.g., a standard deviation) from a statistic (e.g., an average identified at 232 of FIG. 2A) of the training data for the parameter. Programmatic refinement of the predefined deviation defining the control limits can be performed by the testing system at 1252 based on user input data (e.g., 216 of FIG. 2A or 294 of FIG. 2B) labeling the training data as representing nominal or off-nominal events that is received by the testing system at 1254.

As an example, the predefined deviation for control chart alerts can be programmatically determined by at least one of (i.e., one or both of) expanding the predefined deviation relative to the statistic of the training data to include portions of the training data labeled as representing nominal events, or contracting the predefined deviation to exclude portions of the previously received training data labeled as representing off-nominal events on a per-parameter basis. For portions of the training data labeled as off-nominal, the modeling component of the testing system can adjust the predefined deviation (e.g., contract the predefined deviation) to ensure that control chart alerts are generated by the testing system or to increase the quantity of control chart alerts generated for the parameters labeled as off-nominal. Conversely, for portions of the training data labeled as nominal, the modeling component of the testing system can adjust the predefined deviation (e.g., expand the predefined deviation) to ensure that control chart alerts are not generated by the testing system or to reduce the quantity of control chart alerts generated for the parameters labeled as nominal.

In at least some examples, the testing system can improve (e.g., optimize) features of the nominal model (e.g., control bands, control limits, cluster size, cluster quantity, conditions, rules, etc.) in a variety of ways. Such improvements can be responsive to user input received by the testing system that defines the type of features to be improved (e.g., improved features 399 of FIG. 3). Programmatic refinement of features of the nominal model can be performed by the testing system at 1258 based on user input (e.g., 216 of FIG. 2A or 294 of FIG. 2B) labeling the training data as representing nominal or off-nominal events that is received by the testing system at 1254. As an example, an improved feature (e.g., 399 of FIG. 3) of a parameter-specific control band can include no more than a threshold proportion of off-nominal events indicated by one or more labels within the training data of the parameter residing within the parameter-specific control band, or no less than a threshold proportion of nominal events indicated by one or more labels within the training data of the parameter residing outside of the parameter-specific control band. These types of feature improvements can be responsive to user input data defining the feature to be improved (e.g., 399 of FIG. 3) as being no more or no less than the threshold proportion of nominal events indicated by one or more labels within the training data of the parameter residing outside of the parameter-specific control band following programmatic refinement of the nominal model

In another example, the control limits can be improved to reduce (e.g., minimize) the quantity of control chart alerts generated for training data labeled as nominal while also increasing (e.g., maximizing) the quantity of control chart alerts generated for training data labeled as off-nominal. Again, improved features can be defined by user input to the testing system (e.g., as improved features 399 of FIG. 3). Other forms of improvement of the control limits can be provided by the testing system responsive to user input, including expanding the control limits to reduce the quantity of control chart alerts generated for training data labeled as nominal to zero. As yet another example, the testing system can be operated to contract the control limits to increase the quantity of control chart alerts generated for the training data labeled as off-nominal to include all of those off-nominal events. These control limits of the control chart alerts can be subsequently adjusted or control chart alerts for a given parameter can be removed from the nominal model responsive to additional user input received at 1236.

For phase space control chart alerts, at 1256 the method can include programmatically defining the control limits that define the control band based on phase space value sets of the training data for the parameter. Within the context of the phase space control chart alerts, the control limits take the form of the clusters of the phase space values sets of the training data. The clusters for each parameter are defined by a predefined deviation (e.g., a standard deviation) of the phase space value sets from the clusters. For example, a size and/or quantity of clusters can be programmatically defined by the testing system to exclude only X % of the phase space value sets for the training data from the clusters.

As another example, the predefined deviation for phase space control chart alerts can be programmatically determined by expanding the predefined deviation by at least one of increasing the quantity and/or size of the clusters to include portions of the training data labeled as representing nominal events, or contracting the predefined deviation by reducing the quantity and/or size of the clusters to exclude portions of the previously received training data labeled as representing off-nominal events on a per-parameter basis. For portions of the training data labeled as off-nominal, the modeling component of the testing system can adjust the predefined deviation (e.g., contract the predefined deviation) to ensure that phase space control chart alerts are generated by the testing system or to increase the quantity of phase space control chart alerts generated for the parameters labeled as off-nominal. Conversely, for portions of the training data labeled as nominal, the modeling component of the testing system can adjust the predefined deviation (e.g., expand the predefined deviation) to ensure that phase space control chart alerts are not generated by the testing system or to reduce the quantity of phase space control chart alerts generated for the parameters labeled as nominal.

In at least some examples, the testing system can improve the control limits to minimize the quantity of phase space control chart alerts generated for training data labeled as nominal while also increasing or maximizing the quantity of phase space control chart alerts generated for training data labeled as off-nominal. However, other forms of improvement of the control limits defining the clusters can be provided by the testing system, including expanding the control limits to reduce the quantity of phase space control chart alerts generated for training data labeled as nominal to zero. As yet another example, the testing system can be operated to contract the control limits to increase the quantity of phase space control chart alerts generated for the training data labeled as off-nominal to include all of those off-nominal events. These control limits of the phase space control chart alerts can be subsequently adjusted or phase space control chart alerts for a given parameter can be removed from the nominal model responsive to additional user input received at 1236.

For C-chart alerts, at 1260 the method can include programmatically defining the control limits that define the control band based on a predefined deviation (e.g., a standard deviation) from a statistic (e.g., an average identified at 232 of FIG. 2A) of the training data for the parameter for a count of a predefined categorical value within a sampling window of the training data for the parameter. As an example, a quantity or proportion of a predefined categorical value within a sampling window can be increased by the testing system to expand the predefined deviation or reduced to contract the predefined deviation. Alternatively or additionally, a size of the sampling window can be increased or decreased by the testing system to reduce or increase a quantity of C-chart alerts that are generated for a given set of training data, as previously described with reference to FIG. 10B. Programmatic refinement of the predefined deviation defining the control limits for C-chart alerts can be performed by the testing system at 1262 based on user input (e.g., 216 of FIG. 2A or 294 of FIG. 2B) labeling the training data as representing nominal or off-nominal events that is received by the testing system at 1254.

As an example, the predefined deviation for C-chart alerts can be programmatically determined by at least one of expanding the predefined deviation relative to the statistic of the training data to include portions of the training data labeled as representing nominal events, or contracting the predefined deviation to exclude portions of the previously received training data labeled as representing off-nominal events on a per-parameter basis. For portions of the training data labeled as off-nominal, the modeling component of the testing system can adjust the predefined deviation (e.g., contract the predefined deviation) to ensure that C-chart alerts are generated by the testing system or to increase the quantity of control chart alerts generated for the parameters labeled as off-nominal. Conversely, for portions of the training data labeled as nominal, the modeling component of the testing system can adjust the predefined deviation (e.g., expand the predefined deviation) to ensure that C-chart alerts are not generated by the testing system or to reduce the quantity of C-chart alerts generated for the parameters labeled as nominal.

In at least some examples, the testing system can improve the control limits to minimize the quantity of C-chart alerts generated for training data labeled as nominal while also increasing or maximizing the quantity of C-chart alerts generated for training data labeled as off-nominal. However, other forms of improvement of the control limits can be provided by the testing system, including expanding the control limits to reduce the quantity of C-chart alerts generated for training data labeled as nominal to zero. As yet another example, the testing system can be operated to contract the control limits to increase the quantity of C-chart alerts generated for the training data labeled as off-nominal to include all of those off-nominal events. These control limits of the C-chart alerts can be subsequently adjusted or C-alerts for a given parameter can be removed from the nominal model responsive to additional user input received at 1236.

For sequential rule alerts, as part of generating the nominal model at 1222, the testing system can at least initially programmatically define one or more antecedent-consequent rule sets at 1264 by performing rule mining with respect to the training data. At 1266, the testing system can programmatically refine the antecedent-consequent rule sets based on training data labeled as nominal or off-nominal to achieve a target rate of sequential rule alerts for the nominal or off-nominal training data, which can include improving features that include one or more of the following: (1) generating zero sequential rule alerts for training data labeled as nominal, (2) generating each of the sequential rule alerts for training data labeled as off-nominal, (3) achieving a target balance between sequential rule alerts being generated for training data labeled as nominal and the lack of sequential rule alerts being generated for training data labeled as off-nominal. These types of improvements can be defined as an improved feature (e.g., 399 of FIG. 3) responsive to user input data. The antecedent-consequent rule sets can be subsequently adjusted (e.g., by adjusting, adding, or removing antecedents or consequents) or rule sets for a given parameter can be removed from the nominal model responsive to user input data.

Referring again to FIG. 12A, at 1228, if an existing nominal model is available, the nominal model generated at 1222 can be compared to the existing nominal model at 1230 to obtain change information (e.g., 240 of FIG. 2A). Otherwise, the process flow can proceed to operation 1232 without performing the comparison at 1230. At 1232, nominal model information for the nominal model and/or the change information obtained at 1230 can be presented to user(s), such as previously described at 236 of FIG. 2A. As an example, the change information can include textual and/or graphical information showing differences between the nominal model generated at 1222 and the existing nominal model, if any.

At 1236, user input data can be received responsive to presentation of the nominal model information and/or change information. As an example, the user input data can be provided to adjust one or more features of the nominal model, including parameter definitions and alert definitions (e.g., control limits, trigger conditions, sequential rules, etc.). As another examples, the user input data can confirm whether the nominal model should be deployed in place of the existing nominal model. At 1234, if user input data received at 1236 identifies a change to be made to the nominal model, data defining the nominal model can be updated or otherwise adjusted by the testing system at 1238 responsive to the user input data received at 1236.

As an example, with respect to control limits of an alert definition, the method at 1236 can include providing a user interface (e.g., 202 of FIG. 2A) of the modeling component for receiving an adjustment to the one or more control limits of a parameter. The testing system, responsive to the adjustment to the one or more control limits of the parameter received via the user interface, can update the nominal model to include the adjustment to the one or more control limits of the parameter prior to receiving the test data in the testing phase 220 of FIG. 2A.

From 1238, the process flow can return to 1222 where the nominal model is generated with the adjusted data. Otherwise, at 1240, if the user input data received at 1236 indicates that the nominal model is to be deployed to the testing system, the nominal model can be stored at 1242 in a data storage device for subsequent implementation and use by the testing system during the testing phase 220 of FIG. 2A. For example, the nominal model can replace an existing nominal model at 1242. If the nominal model is not to be deployed at 1240, the nominal model can be stored at 1244 in a data storage device as a provisional nominal model. For example, the provisional nominal model can be subsequently accessed and revisited by one or more users to review and/or adjust aspects of the provisional nominal model, and potentially deploy the model to the testing system at a later time.

Referring also to FIG. 12C, symbolic coding of test data/training data can be performed at 1270 by user-applied symbolic coding 1272 performed by users and/or programmatically-applied symbolic coding 1274 performed by the testing system using pattern mining module 394 to define parameter symbol map 672 for each parameter of the nominal model at 1222. As an example, user-applied symbolic coding 1272 can be performed by users assigning symbols (e.g., 676 of FIG. 6) to a value sequence (e.g., 678) of value transitions (e.g., from a first value 680 to a second value 682) to define an encoded value transition (e.g., 674) of parameter symbol map 672 for some or all of the parameters of the nominal model.

To discover patterns of changes across two or more parameters, transitions between variable states for parameters can be coded as symbols within the nominal model. For example, circuit breaker “A” of a test subject switching from open to closed can be assigned symbol “0”, while switching from closed to open can be assigned symbol “1”. A similar approach can be applied, for circuit breaker “B” and other enumerated parameters of a test subject. Pattern mining module 394 of FIG. 3 can be implemented to identify and compress common sequences found in training data into these higher-level symbols.

FIG. 13 depicts an example parameter symbol map 1310 that is an example of symbol map 672 of FIG. 6. Symbol map 1310, in this example, is formatted in the JavaScript Object Notation (JSON) format. Symbol map 1310 encodes value transitions for a small set of parameters, including: “ELCC CONTROLCK2471312 AC FEED-RPDU 84”, “L1GCU_L1ATRUC_MODE_AUTO”, “PDHM_PDUI_CT2409801_NotClosed”, etc. As an example, the “ELCC CONTROLCK2471312 AC FEED-RPDU 84” parameter is coded as having a single symbol “0”, which corresponds to the transition from 12 to 48. As another example, the “PDHM_PDUI_CT2409801_NotClosed” parameter is coded as having two symbols “0” which corresponds to the transition from state 0 to state 1, and “1” which corresponds to the transition from state 1 to state 0.

Referring again to FIG. 12C, programmatically-applied symbolic coding 1274 can be performed by pattern mining module 394 of FIG. 3 executed by the testing computing system to define an encoded value transition of parameter symbol map 672 for some or all of the parameters of the nominal model. In at least some examples, value transitions identified by pattern mining module 394 can undergo user review 1276 prior to those value transitions being used within parameter symbol map 672. For example, users 116 can provide user input via terminals 118 as user input data to accept or decline value transitions proposed by pattern mining module 394 for inclusion in parameter symbol map 672 of the nominal model.

Sequential rule mining of coded test data/training data can be performed at 1280 by defining user-identified sequential rules 1282 identified by users and/or programmatically-identified sequential rules 1284 identified by the testing system using rule mining module 394 to define one or more sequential rule definitions 684 of FIG. 6 with respect to some or all of the parameters of the nominal model at 1222. In at least some examples, sequential rules identified programmatically at 1284 can undergo user review 1286 prior to those value transitions being used within sequential rule definitions 684 of FIG. 6. For example, users 116 can provide user input via terminals 118 as user input data to accept or decline sequential rules proposed by rule mining module 396 for inclusion in sequential rule definitions 684.

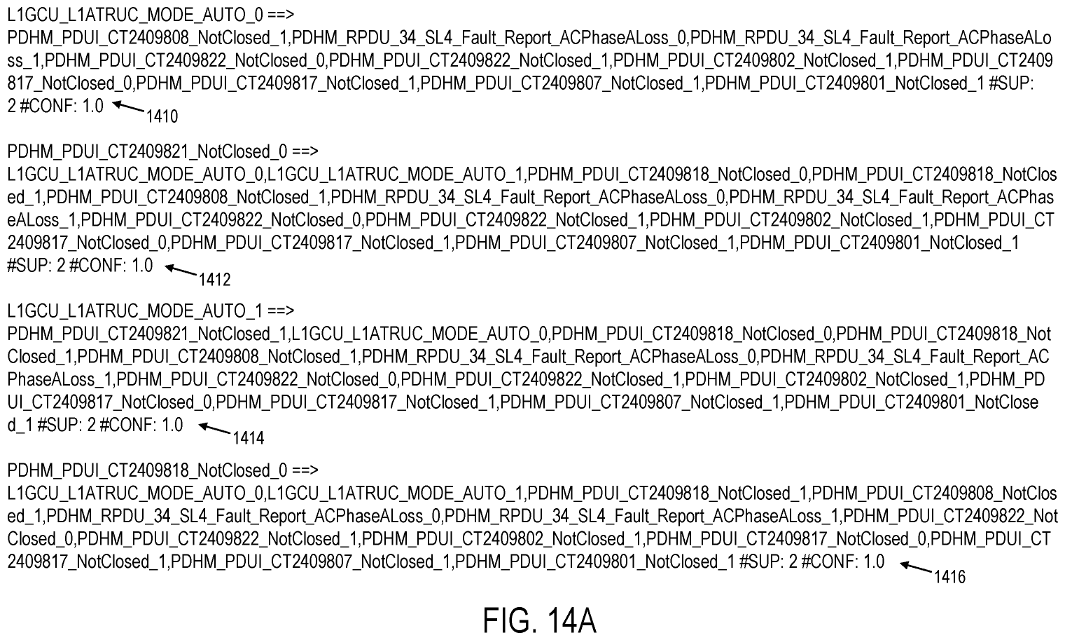

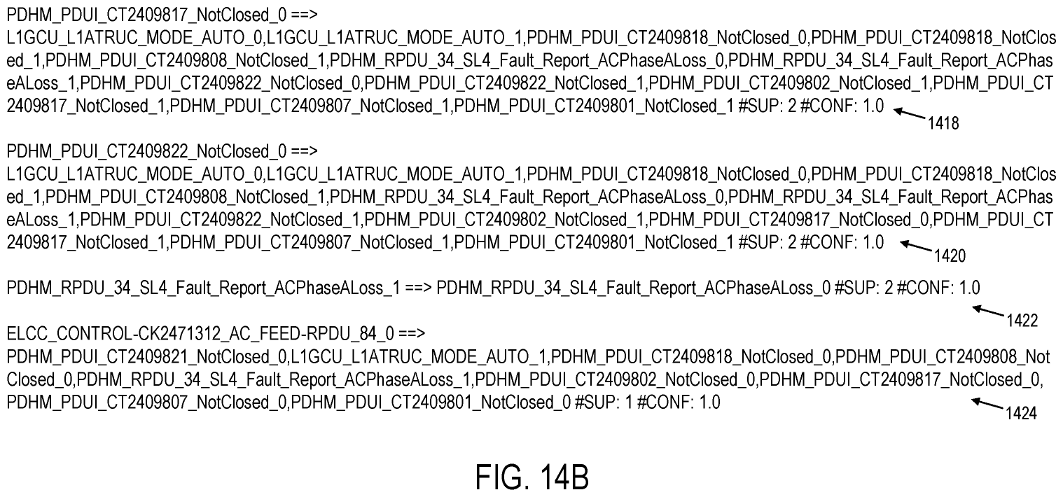

FIGS. 14A-14B shows an example rule set that includes sequential rules definitions 1410-1424, as non-limiting examples of definitions 684. In each of the example rule definitions, the form {antecedent}=>{consequent} is provided. Each encoded value transition is defined as PARAMETER NAME SYM, where “SYM” (e.g., “_0”) refers to the symbol value for that parameter (e.g., as an example of symbol 676 of FIG. 6).

Provided the symbolic time series from the symbol coding routines, it is possible to analyze the series for rules of the form {antecedents}=>{consequents}. These rules state that if the symbols in the set antecedents occur, the symbols in the set consequents should occur afterwards. This process is referred to as rule mining, and it constitutes the training step for pattern discovery within modeling component 344.

In at least some examples, rule mining relies on a few parameters that are not easily tuned or discovered without subject matter knowledge. For instance, the time scale of rule relationships that are interesting, and the minimum confidence required to establish a rule. Design engineers could be asked to contribute to the tuning of these parameters. Furthermore, in at least some examples, a method such as Recurrence Quantification Analysis (RQA) could be used to develop an additional nominal model which captures all parameter values at each time point as a state, and characterizes temporal recurrences of similar states. The nominal model in this case could be based on metrics computed on the recurrence matrix plotted over time, i.e. a parameterization of these nominal curves could be used to issue alerts based on deviations from them.

Generating alerts based on sequential rules relies on the discovery of rule violations. Once the symbol map for each parameter has been established, a time series can be easily and efficiently mapped to those symbols. For each symbol, the set of antecedent sets is searched by the testing system, and each set that contains the symbol is marked. If all antecedents in a rule have been seen, then the same process begins marking symbols in the consequent set. If not all symbols in the consequent set are seen, that constitutes a rule violation.

An example output of a rule violation alert could take the form of a JSON document that indicates: “{“alert_data”: null, “alert desc”: “Sequential rule alert”, “alert_name”: “sequential-rule”, “date”: 1574302889.499854, “extra_info”: {“antecedent”: [3,12,32], “consequent”:[42,56,90], “missing_consequent”:[90]}}”, where the antecedent and consequent steps can be translated using the itemset and parameter maps described above.

FIG. 15 is a flow diagram depicting features of an example workflow 1500 with respect to the training phase 222 of FIG. 2A. Similar to previously described workflow 500 of FIG. 5 for testing phase 220, workflow 1500 of FIG. 15 can be performed by instructions 322 executed by testing computing system 120. In this example, modeling component 344 of FIG. 3 can compare new training data 1510 with an existing nominal model 1524 at 1512. The comparison at 1510 can be performed by one or more processing modules 1514, as an example. At 1516, statistics (e.g., 234 of FIG. 2A) and change information (e.g., 240 of FIG. 2A) can be generated and saved for review by a user. At 1518, the user can provide user input to indicate whether the new or updated nominal model is to be deployed, and if the model is to be deployed, the nominal model is updated at 1520, for example, by one or more processing models 1522. The updated nominal model is then deployed in place of existing nominal model 1524.

In at least some examples, training of the nominal model can be a relatively slower process than testing using the nominal model. Accordingly, training can be performed offline using any suitable quantity of training data sets obtained from respective training subjects. Testing, on the other hand, can be performed in real-time or near-real-time as new testing data is being received. Applying the symbol coding of parameter value sequences, learned rules can be used by the testing system to look for invalid or unexpected, off-nominal sequences of transitions. In a data streaming process, value transitions can be checked against a superset of antecedents, and any matching sets can trigger a search by the testing system for the occurrence of consequents in subsequent data within the data stream. If those consequents do not subsequently occur within the data stream, a rule violation is determined to have occurred by the testing system and an alert can be generated.

The types of rules discovered by the modeling component of the testing system can depend on the validity and appropriateness of the symbolic coding. Since rule discovery can be programmatically performed and is therefore unsupervised, and because rule discovery can be based on a potentially limited amount of training data, rules can contain relationships that are not meaningful or just occur due to happenstance in some cases. These rules can be mitigated by using some manual review by users with subject matter knowledge as a rule filter.

In some at least some examples, the methods and operations described herein can be tied to a computing system of one or more computing devices. In particular, such methods and operations can be implemented as one or more computer-application programs, a computer-implemented service, an application-programming interface (API), a computer data library, and/or other set of machine-executable instructions.

As previously described, FIG. 1 schematically shows an example of a computing system (e.g., 120) that includes one or more computing devices (e.g., 122). A computing system or computing devices thereof can take the form of one or more personal computers, server computers, tablet computers, networking computers, mobile computers, and/or other computing devices. While components of an example computing system are described in further detail below, it will be understood that any of the computing systems or computing devices described herein (e.g., on-board computing system 140) can also include a logic subsystem, a storage subsystem, an input/output subsystem, and other suitable components.

A logic subsystem, such as example logic subsystem 124 of testing computing system 120, includes one or more physical devices (e.g., logic devices 126) configured to execute instructions. For example, a logic subsystem can be configured to execute instructions that are part of one or more applications, services, programs, routines, libraries, objects, components, data structures, or other logical constructs. Such instructions can be implemented to perform a task, implement a data type, transform the condition of one or more components, achieve a technical effect, or otherwise arrive at a desired result.

A logic subsystem can include one or more processor devices configured to execute software instructions. Additionally or alternatively, a logic subsystem can include one or more hardware or firmware logic subsystems configured to execute hardware or firmware instructions. Processor devices of a logic subsystem can be single-core or multi-core, and the instructions executed thereon can be configured for sequential, parallel, and/or distributed processing. Individual components of a logic subsystem can be distributed among two or more separate devices, and can be remotely located and/or configured for coordinated processing. Aspects of a logic subsystem can be virtualized and executed by remotely accessible, networked computing devices configured in a cloud-computing configuration.

A storage subsystem, such as example storage subsystem 128 of testing computing system 120, includes one or more physical data storage devices 130 configured to hold instructions executable by the logic subsystem to implement the methods and operations described herein. When such methods and operations are implemented, a condition or state of the storage subsystem can be transformed—e.g., to hold different data. The storage subsystem can include removable and/or built-in devices. A storage subsystem can include optical memory (e.g., CD, DVD, etc.), semiconductor memory (e.g., RAM, EPROM, EEPROM, etc.), and/or magnetic memory (e.g., hard-disk drive, floppy-disk drive, tape drive, MRAM, etc.), among others. A storage subsystem can include volatile, nonvolatile, dynamic, static, read/write, read-only, random-access, sequential-access, location-addressable, file-addressable, and/or content-addressable devices. While a storage subsystem, such as storage subsystem 128, includes one or more physical devices, aspects of the executable instructions described herein alternatively can be propagated by a communication medium (e.g., an electromagnetic signal, an optical signal, etc.) that is not held by a physical device for a finite duration, under at least some conditions.

Aspects of a logic subsystem and a storage subsystem of a computing device or computing system can be integrated together into one or more hardware-logic components. Such hardware-logic components can include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module” and “program” are used herein to describe an aspect of a computing system implemented to perform a particular function. In at least some examples, a module or program can be instantiated via a logic subsystem executing instructions held by or retrieved from a storage subsystem. It will be understood that different modules or programs can be instantiated from the same application, service, code block, object, library, routine, API, function, etc. Likewise, the same module or program can be instantiated by different applications, services, code blocks, objects, routines, APIs, functions, etc. The terms “module” or “program” can encompass individual or groups of executable files, data files, libraries, drivers, scripts, database records, etc.

In at least some examples, the computer executable instructions disclosed herein can take the form of a service that refers to program executable across multiple user sessions. A service can be available to one or more system components, programs, and/or other services. As an example, a service can run on one or more server computing devices.

An input/output subsystem, such as example input/output subsystem 132 of FIG. 1, can include or interface with one or more user input devices such as a keyboard, mouse, touch screen, handheld controller, microphone, camera, etc.; one or more output devices such as a display device, audio speaker, printer, etc.; and a communications interface with one or more other devices.

A display device (e.g., associated with terminals 118) can be used to present a visual representation of data held by a storage subsystem of a computing device or computing system. This visual representation can take the form of a GUI. As the herein described methods and operations can change the data held by a storage subsystem, and thus transform the condition or state of the storage subsystem, the condition or state of the display device can likewise be transformed to visually represent changes in the underlying data. Display devices can be combined with a logic subsystem and/or a storage subsystem of a computing device or computing system in a shared enclosure, or such display devices can be peripheral display devices.

A communications interface of a computing system can be used to communicatively couple the computing system with one or more other computing devices or computing systems. The communications interface can include wired and/or wireless communication devices compatible with one or more different communication protocols. The communications interface can be configured for communication via a wireless telephone network, or a wired or wireless local- or wide-area network, an on-board or integrated data network of a training or test subject (e.g., 142 of FIG. 1) as examples. In at least some examples, the communications interface can allow the computing system to send and/or receive messages to and/or from other devices via a network (e.g., 104 of FIG. 1), which can include the Internet or a portion thereof.

Machine learning module 398 can be implemented using any suitable combination of state-of-the-art and/or future machine learning (ML), artificial intelligence (AI), statistical, and/or natural language processing (NLP) techniques, for example via one or more previously-trained ML, AI, NLP, and/or statistical models. Examples of techniques that can be incorporated in an implementation of the machine-learning module include support vector machines, multi-layer neural networks, convolutional neural networks (e.g., including spatial convolutional networks for processing images and/or videos, temporal convolutional neural networks for processing audio signals and/or natural language sentences, and/or any other suitable convolutional neural networks configured to convolve and pool features across one or more temporal and/or spatial dimensions), recurrent neural networks (e.g., long short-term memory networks), associative memories (e.g., lookup tables, hash tables, Bloom Filters, Neural Turing Machine and/or Neural Random Access Memory), word embedding models (e.g., GloVe or Word2Vec), unsupervised spatial and/or clustering methods (e.g., nearest neighbor algorithms, topological data analysis, and/or k-means clustering), graphical models (e.g., (hidden) Markov models, Markov random fields, (hidden) conditional random fields, and/or AI knowledge bases), and/or natural language processing techniques (e.g., tokenization, stemming, constituency and/or dependency parsing, and/or intent recognition, segmental models, and/or super-segmental models (e.g., hidden dynamic models)).

In some examples, the methods and processes described herein can be implemented using one or more differentiable functions, wherein a gradient of the differentiable functions can be calculated and/or estimated with regard to inputs and/or outputs of the differentiable functions (e.g., with regard to training data, and/or with regard to an objective function). Such methods and processes can be at least partially determined by a set of trainable parameters. Accordingly, the trainable parameters for a particular method or process can be adjusted through any suitable training procedure, in order to continually improve functioning of the method or process. The nominal models described herein can be “configured” by the machine-learning module based on training, e.g., by training the nominal model with a plurality of training data instances suitable to cause an adjustment to the trainable parameters, resulting in a described configuration.

Non-limiting examples of training procedures for adjusting trainable parameters include supervised training (e.g., using gradient descent or any other suitable feature improvement method), zero-shot, few-shot, unsupervised learning methods (e.g., classification based on classes derived from unsupervised clustering methods), reinforcement learning (e.g., deep Q learning based on feedback) and/or generative adversarial neural network training methods, belief propagation, RANSAC (random sample consensus), contextual bandit methods, maximum likelihood methods, and/or expectation maximization. In some examples, a plurality of methods, processes, and/or components of systems described herein can be trained simultaneously with regard to an objective function measuring performance of collective functioning of the plurality of components (e.g., with regard to reinforcement feedback and/or with regard to labelled training data). Simultaneously training the plurality of methods, processes, and/or components can improve such collective functioning. In some examples, one or more methods, processes, and/or components can be trained independently of other components (e.g., offline training on historical data).

The machine-learning module as described herein can incorporate any suitable combination of AI, ML, NLP, and/or statistical models. For example, the machine-learning module can include one or more models configured as an ensemble, and/or one or more models in any other suitable configuration. The nominal models described herein can be trained or otherwise programmatically refined, at least in part, by the machine-learning module using any suitable data, including training data, improved features (e.g., 399), and labels identifying the training data as being nominal or off-nominal.

Examples of the subject matter of the subject disclosure are described in the following enumerated paragraphs.

A.1. A testing method performed by a computing system with respect to an electro-mechanical test subject, the method comprising:

receiving test data for the electro-mechanical test subject, the test data comprising a set of data streams from a set of sensors associated with the test subject, each data stream representing a time-based series of measurements of a parameter of a plurality of parameters measured for the test subject; obtaining a nominal model defining a parameter-specific control band for each parameter of the test subject, wherein one or more control limits defining each parameter-specific control band that have been identified through training of the nominal model on previously received training data for one or more electro-mechanical training subjects belonging to a class of which the test subject is a member; and processing the set of data streams of the test data for the test subject in combination with the nominal model by, for each parameter of the test subject: selecting a parameter-specific control band defined by the nominal model for the parameter; comparing the time-based series of measurements of the parameter to the parameter-specific control band for the parameter, and selectively generating a test result for the parameter responsive to whether a condition is satisfied with respect to any of the time-based series of measurements exceeding the parameter-specific control band for the parameter.

A.2. The method of paragraph A.1, further comprising: receiving user input data identifying the test result generated for a select parameter of the plurality of parameters as representing a nominal event or an off-nominal event; labeling the test data for the select parameter with an indication of the nominal event or off-nominal event identified by the user input data to obtain labeled test data; providing the labeled test data to a machine-learning module as labeled training data representing a ground truth for the select parameter; and generating an updated nominal model by the machine-learning module responsive to the labeled training data.

A.3. The method of any of paragraphs A.1-A.2, wherein the one or more control limits defining the parameter-specific control band for at least some of the plurality of parameters are programmatically defined based, at least in part, on a predefined deviation from a statistic of the training data for that parameter; and wherein the method further comprises: providing a user interface for receiving an adjustment to the one or more control limits of a parameter; receiving the adjustment to the one or more control limits of the parameter via the user interface; and updating the nominal model to include the adjustment to the one or more control limits of the parameter prior to processing the test data.

A.4. The method of any of paragraphs A.1-A.3, further comprising, for each parameter: identifying whether the parameter is an ordinal parameter based on a parameter definition of the nominal model; responsive to identifying the parameter as an ordinal parameter, comparing the time-based series of measurements of the parameter to the parameter-specific control band for the parameter to identify any of the time-based series of measurements that exceed the parameter-specific control band; and wherein the test result that is generated indicates an off-nominal event with respect to the ordinal parameter responsive to the condition of one or more of the time-based series of measurements exceeding the parameter-specific control band.

A.5. The method of paragraph A.4, wherein for the ordinal parameter, the one or more control limits of the parameter-specific control band are defined, based at least in part, on a predefined deviation for the parameter from an average of the previously received training data.

A.6. The method of paragraph A.5, wherein the predefined deviation is programmatically determined by the computing system by at least one of (i.e., one or both of): expanding the predefined deviation to include portions of the previously received training data for the parameter labeled as representing a nominal event, or contracting the predefined deviation to exclude portions of the previously received training data for the parameter labeled as representing an off-nominal event.

A.7. The method of any of paragraphs A.1-A.6, further comprising, for each parameter: identifying whether the parameter is an ordinal parameter based on a parameter definition of the nominal model; and responsive to identifying the parameter as an ordinal parameter: determining a phase space value set for each of the time-based series of measurements, the phase space value set for a current value of the time-based series of measurements being defined as having: a first value corresponding to a previous value to the current value in the time-based series of measurements, and a second value corresponding to a difference between the current value and the previous value, and comparing the phase space value sets to the parameter-specific control band as one of a plurality of clusters of phase space value sets of the previously received training data, wherein the test result that is generated indicates an off-nominal event with respect to the ordinal parameter responsive to the condition of any of the phase space value sets of the test data exceeding each of the plurality of clusters of the phase space value sets of the training data.

A.8. The method of paragraph A.7, wherein for the ordinal parameter, the plurality of clusters of the phase space value sets are defined, based at least in part, on a predefined deviation from corresponding phase space value sets of the previously received training data for the ordinal parameter.

A.9. The method of paragraph A.8, wherein the predefined deviation defining the plurality of clusters is programmatically determined by at least one of: expanding the predefined deviation to increase at least one of a size or a quantity of the plurality of clusters to include portions of the previously received training data for the parameter labeled as representing a nominal event, or contracting the predefined deviation to reduce at least one of the size or the quantity of the plurality of clusters to exclude portions of the previously received training data for the parameter labeled as representing an off-nominal event.

A.10. The method of any of paragraphs A.1-A.3, further comprising, for each parameter: identifying whether the parameter is a categorical parameter based on a parameter definition of the nominal model; and responsive to identifying the parameter as the categorical parameter: determining a quantity or a proportion of values of the time-based series of measurements of a predefined categorical value that exceed a control limit of the parameter-specific control band within a sampling window defined by the condition of the nominal model, wherein the test result that is generated indicates an off-nominal event with respect to the categorical parameter responsive to the quantity or the proportion of values exceeding the control limit within the sampling window.

A.11. The method of paragraph A.10, wherein for the categorical parameter, the one or more control limits of the parameter-specific control band are defined, based at least in part, on a predefined deviation for the parameter from an average quantity or an average proportion of values of the previously received training data within the sampling window.

A.12. The method of paragraph A.11, wherein the predefined deviation is programmatically determined by the computing system by at least one of: expanding the predefined deviation to include portions of the previously received training data for the parameter labeled as representing a nominal event, or contracting the predefined deviation to exclude portions of the previously received training data for the parameter labeled as representing an off-nominal event.

A.13. The method of any of paragraphs A.1-A.12, further comprising, for a first parameter of the plurality of parameters, identifying whether an antecedents set of one or more value transitions defined by the nominal model is present within the time-based series of measurements of the test data for the first parameter; responsive to identifying the antecedents set for the first parameter, identifying whether a consequents set of one or more value transitions defined by the nominal model is present within the time-based series of measurements of the test data for a second parameter subsequent to the antecedents set; and selectively generating the test result responsive to whether the antecedents set and the consequents set are present within the test data for the test subject.

A.14. The method of any of paragraphs A.1-A.13, wherein the electro-mechanical test subject is an aircraft; and wherein the test data is received as packetized, encoded data transmitted over a common data network (CDN) integrated with the aircraft; and wherein the method further comprises, decoding and filtering the packetized, encoded data to obtain the set of data streams for the plurality of parameters.

A.15. The method of any of paragraphs A.1-A.14, further comprising: identifying an initiating event with respect to the electro-mechanical test subject; wherein the parameter-specific control band for one or more of the plurality of parameters is a time-varying control band relative to the initiating event; and wherein the method further comprises, comparing the time-based series of measurements of the one or more parameters relative to the initiating event to a time-aligned portion of the time-varying control band for the parameter relative to the initiating event.

B.1. A method of training a testing system for testing an electro-mechanical test subject, the method comprising: for each of a plurality of electro-mechanical training subjects belonging to a class of which the electro-mechanical test subject is a member, receiving a set of training data for a training subject that comprises a time-based series of measurements for each of a plurality of parameters measured by a set of sensors associated with the training subject; for each parameter of the plurality of parameters: computing one or more parameter statistic values of the time-based series of measurements of the parameter across the plurality of electro-mechanical training subjects, and identifying one or more control limits defining a parameter-specific control band for the parameter based on the one or more parameter statistic values computed for the parameter; generating a nominal model that comprises, for each of the plurality of parameters, the one or more control limits defining the parameter-specific control band for the parameter; and storing the nominal model in a data storage device for subsequent implementation by the testing system to selectively generate a test result for each of the plurality of parameters for the test subject based on a comparison of test data received from sensors associated with the test subject to the one or more control limits.

B.2. The method of paragraph B.1, further comprising: receiving user input data identifying the test result generated for a select parameter of the plurality of parameters as representing a nominal event or an off-nominal event; labeling the test data for the select parameter with an indication of the nominal event or off-nominal event identified by the user input data to obtain labeled test data; providing the labeled test data to a machine-learning module as labeled training data representing a ground truth for the select parameter; and generating an updated nominal model by the machine-learning module responsive to the labeled training data, the updated nominal model defining one or more refined parameter-specific control bands.

B.3. The method of any of paragraphs B.1-B.2, further comprising: providing a user interface for receiving an adjustment to the one or more control limits of a parameter of the plurality of parameters; receiving the adjustment to the one or more control limits of the parameter via the user interface; and updating the nominal model to include the adjustment to the one or more control limits of the parameter.

C.1. A testing system, comprising a computing system programmed with instructions executable by the computing system to: during an initial phase: for each of a plurality of electro-mechanical training subjects, receive a set of training data for the training subject that comprises a time-based series of measurements for each of a plurality of parameters measured by a set of sensors associated with the training subject; for each parameter of the plurality of parameters: compute one or more parameter statistic values representing a filtered combination of the time-based series of measurements of the parameter across the plurality of training subjects, and identify one or more control limits defining a parameter-specific control band for the parameter based on the one or more parameter statistic values computed for the parameter; generate a nominal model that includes, for each of the plurality of parameters, the one or more parameter-specific control limits defining the parameter-specific control band for the parameter; during a testing phase subsequent to the initial phase: receive test data for an electro-mechanical test subject that comprises a time-based series of measurements for each of the plurality of parameters measured by a set of sensors associated with the test subject; process the test data for the test subject in combination with the nominal model by, for each parameter of the plurality of parameters: comparing the time-based series of measurements of the parameter of the test data to the parameter-specific control band for the parameter, and selectively generating a test result for the parameter responsive to whether a condition is satisfied with respect to any of the time-based series of measurements of the test data exceeding the parameter-specific control band for the parameter.

C.2 The testing system of paragraph C.1, wherein the one or more control limits for the parameter are identified by the computing system programmatically defining the one or more control limits based on a predefined deviation from at least one of the parameter statistic values computed for the parameter.

It will be understood that the configurations and techniques described herein are exemplary in nature, and that specific embodiments and examples are not to be considered in a limiting sense, because numerous variations are possible. The specific methods described herein can represent one or more of any number of processing strategies. As such, the disclosed operations can be performed in the disclosed sequence, in other sequences, in parallel, or omitted, in at least some examples. Thus, the order of the above-described operations can be changed, in at least some examples. The subject matter of the subject disclosure includes all novel and non-obvious combinations and sub-combinations of the various methods, systems, configurations, and other features, functions, acts, and/or properties disclosed herein, as well as any and all equivalents thereof.

1. A testing method performed by a computing system with respect to an electro-mechanical test subject, the method comprising:
receiving test data for the electro-mechanical test subject, the test data comprising a set of data streams from a set of sensors associated with the test subject, each data stream representing a time-based series of measurements of a parameter of a plurality of parameters measured for the test subject;
obtaining a nominal model defining a parameter-specific control band for each parameter of the test subject, wherein one or more control limits defining each parameter-specific control band that have been identified through training of the nominal model on previously received training data for one or more electro-mechanical training subjects belonging to a class of which the test subject is a member; and
processing the set of data streams of the test data for the test subject in combination with the nominal model by, for each parameter of the test subject:
selecting a parameter-specific control band defined by the nominal model for the parameter;
comparing the time-based series of measurements of the parameter to the parameter-specific control band for the parameter, and
selectively generating a test result for the parameter responsive to whether a condition is satisfied with respect to any of the time-based series of measurements exceeding the parameter-specific control band for the parameter.

2. The method of claim 1, further comprising:
receiving user input data identifying the test result generated for a select parameter of the plurality of parameters as representing a nominal event or an off-nominal event;
labeling the test data for the select parameter with an indication of the nominal event or off-nominal event identified by the user input data to obtain labeled test data;
providing the labeled test data to a machine-learning module as labeled training data representing a ground truth for the select parameter; and
generating an updated nominal model by the machine-learning module responsive to the labeled training data.

3. The method of claim 1, wherein the one or more control limits defining the parameter-specific control band for at least some of the plurality of parameters are programmatically defined based, at least in part, on a predefined deviation from a statistic of the training data for that parameter; and
wherein the method further comprises:
providing a user interface for receiving an adjustment to the one or more control limits of a parameter;
receiving the adjustment to the one or more control limits of the parameter via the user interface; and
updating the nominal model to include the adjustment to the one or more control limits of the parameter prior to processing the test data.

4. The method of claim 1, further comprising, for each parameter: identifying whether the parameter is an ordinal parameter based on a parameter definition of the nominal model;
responsive to identifying the parameter as an ordinal parameter, comparing the time-based series of measurements of the parameter to the parameter-specific control band for the parameter to identify any of the time-based series of measurements that exceed the parameter-specific control band; and
wherein the test result that is generated indicates an off-nominal event with respect to the ordinal parameter responsive to the condition of one or more of the time-based series of measurements exceeding the parameter-specific control band.

5. The method of claim 4, wherein for the ordinal parameter, the one or more control limits of the parameter-specific control band are defined, based at least in part, on a predefined deviation for the parameter from an average of the previously received training data.

6. The method of claim 5, wherein the predefined deviation is programmatically determined by the computing system by at least one of:
expanding the predefined deviation to include portions of the previously received training data for the parameter labeled as representing a nominal event, or
contracting the predefined deviation to exclude portions of the previously received training data for the parameter labeled as representing an off-nominal event.

7. The method of claim 1, further comprising, for each parameter: identifying whether the parameter is an ordinal parameter based on a parameter definition of the nominal model; and
responsive to identifying the parameter as an ordinal parameter:
determining a phase space value set for each of the time-based series of measurements, the phase space value set for a current value of the time-based series of measurements being defined as having:
a first value corresponding to a previous value to the current value in the time-based series of measurements, and
a second value corresponding to a difference between the current value and the previous value, and
comparing the phase space value sets to the parameter-specific control band as one of a plurality of clusters of phase space value sets of the previously received training data,
wherein the test result that is generated indicates an off-nominal event with respect to the ordinal parameter responsive to the condition of any of the phase space value sets of the test data exceeding each of the plurality of clusters of the phase space value sets of the training data.

8. The method of claim 7, wherein for the ordinal parameter, the plurality of clusters of the phase space value sets are defined, based at least in part, on a predefined deviation from corresponding phase space value sets of the previously received training data for the ordinal parameter.

9. The method of claim 8, wherein the predefined deviation defining the plurality of clusters is programmatically determined by at least one of:
expanding the predefined deviation to increase at least one of a size or a quantity of the plurality of clusters to include portions of the previously received training data for the parameter labeled as representing a nominal event, or
contracting the predefined deviation to reduce at least one of the size or the quantity of the plurality of clusters to exclude portions of the previously received training data for the parameter labeled as representing an off-nominal event.

10. The method of claim 1, further comprising, for each parameter: identifying whether the parameter is a categorical parameter based on a parameter definition of the nominal model; and
responsive to identifying the parameter as the categorical parameter:
determining a quantity or a proportion of values of the time-based series of measurements of a predefined categorical value that exceed a control limit of the parameter-specific control band within a sampling window defined by the condition of the nominal model,
wherein the test result that is generated indicates an off-nominal event with respect to the categorical parameter responsive to the quantity or the proportion of values exceeding the control limit within the sampling window.

11. The method of claim 10, wherein for the categorical parameter, the one or more control limits of the parameter-specific control band are defined, based at least in part, on a predefined deviation for the parameter from an average quantity or an average proportion of values of the previously received training data within the sampling window.

12. The method of claim 11, wherein the predefined deviation is programmatically determined by the computing system by at least one of:
expanding the predefined deviation to include portions of the previously received training data for the parameter labeled as representing a nominal event, or
contracting the predefined deviation to exclude portions of the previously received training data for the parameter labeled as representing an off-nominal event.

13. The method of claim 1, further comprising, for a first parameter of the plurality of parameters, identifying whether an antecedents set of one or more value transitions defined by the nominal model is present within the time-based series of measurements of the test data for the first parameter;
responsive to identifying the antecedents set for the first parameter, identifying whether a consequents set of one or more value transitions defined by the nominal model is present within the time-based series of measurements of the test data for a second parameter subsequent to the antecedents set; and
selectively generating the test result responsive to whether the antecedents set and the consequents set are present within the test data for the test subject.

14. The method of claim 1, wherein the electro-mechanical test subject is an aircraft; and
wherein the test data is received as packetized, encoded data transmitted over a common data network (CDN) integrated with the aircraft; and
wherein the method further comprises, decoding and filtering the packetized, encoded data to obtain the set of data streams for the plurality of parameters.

15. The method of claim 1, further comprising:
identifying an initiating event with respect to the electro-mechanical test subject;
wherein the parameter-specific control band for one or more of the plurality of parameters is a time-varying control band relative to the initiating event; and
wherein the method further comprises, comparing the time-based series of measurements of the one or more parameters relative to the initiating event to a time-aligned portion of the time-varying control band for the parameter relative to the initiating event.

16. A method of training a testing system for testing an electro-mechanical test subject, the method comprising:
for each of a plurality of electro-mechanical training subjects belonging to a class of which the electro-mechanical test subject is a member, receiving a set of training data for a training subject that comprises a time-based series of measurements for each of a plurality of parameters measured by a set of sensors associated with the training subject;
for each parameter of the plurality of parameters:
computing one or more parameter statistic values of the time-based series of measurements of the parameter across the plurality of electro-mechanical training subjects, and
identifying one or more control limits defining a parameter-specific control band for the parameter based on the one or more parameter statistic values computed for the parameter;
generating a nominal model that comprises, for each of the plurality of parameters, the one or more control limits defining the parameter-specific control band for the parameter; and
storing the nominal model in a data storage device for subsequent implementation by the testing system to selectively generate a test result for each of the plurality of parameters for the test subject based on a comparison of test data received from sensors associated with the test subject to the one or more control limits.

17. The method of claim 16, further comprising:
receiving user input data identifying the test result generated for a select parameter of the plurality of parameters as representing a nominal event or an off-nominal event;
labeling the test data for the select parameter with an indication of the nominal event or off-nominal event identified by the user input data to obtain labeled test data;
providing the labeled test data to a machine-learning module as labeled training data representing a ground truth for the select parameter; and
generating an updated nominal model by the machine-learning module responsive to the labeled training data, the updated nominal model defining one or more refined parameter-specific control bands.

18. The method of claim 16, further comprising:
providing a user interface for receiving an adjustment to the one or more control limits of a parameter of the plurality of parameters;
receiving the adjustment to the one or more control limits of the parameter via the user interface; and
updating the nominal model to include the adjustment to the one or more control limits of the parameter.

19. A testing system, comprising a computing system programmed with instructions executable by the computing system to:
during an initial phase:
for each of a plurality of electro-mechanical training subjects, receive a set of training data for a training subject that comprises a first time-based series of measurements for each of a plurality of parameters measured by a first set of sensors associated with the training subject;
for each parameter of the plurality of parameters:
compute one or more parameter statistic values representing a filtered combination of the first time-based series of measurements of the parameter across the plurality of electro-mechanical training subjects, and
identify one or more control limits defining a parameter-specific control band for the parameter based on the one or more parameter statistic values computed for the parameter; and
generate a nominal model that comprises, for each of the plurality of parameters, the one or more parameter-specific control limits defining the parameter-specific control band for the parameter;
during a testing phase subsequent to the initial phase:
receive test data for an electro-mechanical test subject that comprises a second time-based series of measurements for each of the plurality of parameters measured by a second set of sensors associated with the test subject; and
process the test data for the test subject in combination with the nominal model by, for each parameter of the plurality of parameters:
comparing the second time-based series of measurements of the parameter of the test data to the parameter-specific control band for the parameter, and
selectively generating a test result for the parameter responsive to whether a condition is satisfied with respect to any of the time-based series of measurements of the test data exceeding the parameter-specific control band for the parameter.

20. The testing system of claim 19, wherein the one or more control limits for the parameter are identified by the computing system programmatically defining the one or more control limits based on a predefined deviation from at least one of the parameter statistic values computed for the parameter.
